(19) United States
(12) Patent Application Publication
(10) Pub. No.: US 2025/0223202 A1
(43) Pub. Date: Jul. 10, 2025

(54) Integrated Divalent Ion Precipitation And Bipolar Electrodialysis Reactor

(71) Applicant: Ebb Carbon, Inc., San Carlos, CA (US)

(72) Inventors: Jeremy Loretz, Burlingame, CA (US); Aparna Garg, Redwood City, CA (US); McLain E.S. Leonard, Palo Alto, CA (US); Sophia Y. Hegeman, Oakland, CA (US); Matthew Eisaman, Port Jefferson, NY (US); Todd Pelman, Moss Beach, CA (US)

(73) Assignee: Ebb Carbon, Inc., San Carlos, CA (US)

(21) Appl. No.: 18/910,483

(22) Filed: Oct. 9, 2024

Related U.S. Application Data
(60) Provisional application No. 63/618,782, filed on Jan. 8, 2024.

(51) Int. Cl. C02F 1/469; C02F 103/08

(52) U.S. Cl. CPC C02F 1/4695; C02F 2103/08; C02F 2201/46115; C02F 2201/4612; C02F 2201/4618; C02F 2209/06

(57) ABSTRACT

A system utilizes an electrochemical reactor to convert salt into acid and base products. The salt is sourced from seawater, brine or another aqueous salt feedstock solution that typically also includes divalent ions. A small (slipstream) portion of the base product generated by the electrochemical reactor is fed back to a chemical precipitator where it is utilized to increase a pH level of the aqueous salt feedstock solution above a precipitation level of at least some the divalent ions, thereby causing precipitation of the divalent ions into insoluble solids. The insoluble solids are then filtered or otherwise separated/removed from the remaining supernatant solution (i.e., the aqueous salt/base solution formed by a mixture of the residual aqueous salt feedstock solution and base product). The supernatant solution is then supplied to the electrochemical reactor for conversion of its salt into additional acid and base product.

### RELATED APPLICATIONS/PATENTS

This application claims priority from U.S. Provisional Patent Application No. 63/618,782, entitled “Integrated Divalent Ion Precipitation And Bipolar Electrodialysis Reactor”, which was filed on Jan. 8, 2024.

### FIELD OF THE INVENTION

The invention generally relates to systems and methods that utilize bipolar electrodialysis to generate base and/or acid products by electrochemically processing salt, and more particularly to ocean alkalinity enhancement systems that utilize the base product to both reduce atmospheric carbon dioxide (CO₂) and mitigate ocean acidification.

### BACKGROUND

As humans burn more and more fossil fuels, the resulting increased carbon dioxide (CO₂) concentration in Earth's atmosphere causes both climate change and ocean acidification. The increased atmospheric concentrations of CO₂ and other greenhouse gasses (e.g., methane) produces climate change by trapping heat close to earth's surface, thereby increasing both air and sea temperatures. Because earth's oceans absorb about 25% of atmospheric CO₂, and because the absorbed CO₂ dissolves to form carbonic acid that remains trapped in the seawater, the increased atmospheric CO₂ concentration caused by burning fossil fuels also produces ocean acidification by way of increasing the amount of CO₂ gas dissolved in the ocean.

Both climate change and ocean acidification pose significant threats to humans. Climate change in the form of increased global average temperatures can produce several dangerous effects such as the loss of polar ice and corresponding increased sea levels, disease, wildfires and stronger storms and hurricanes. Ocean acidification changes the ocean chemistry that most marine organisms rely on. One concern with ocean acidification is that the decreased seawater pH can lead to the decreased survival of shellfish and other aquatic life having calcium carbonate shells, as well as some other physiological challenges for marine organisms.

To avoid dangerous climate change, the international Paris Agreement aims to limit the increase in global average temperature to no more than 1.5° C. to 2° C. above the temperatures of the pre-industrial era. Global average temperatures have already increased by between 0.8° C. and 1.2° C. The Intergovernmental Panel on Climate Change (IPCC) estimates that a ‘carbon budget’ of about 500 GtCO₂ (billion tons of carbon dioxide), which corresponds to about ten years at current emission rates, provides a 66% chance of limiting climate change to 1.5° C.

In addition to cutting CO₂ emissions by curtailing the use of fossil fuels, climate models predict that a significant deployment of Negative Emissions Technologies (NETs) will be needed to avoid catastrophic ocean acidification and global warming beyond 1.5° C. (see “Biophysical and economic limits to negative CO₂ emissions”, Smith, P. et al., Nat. Clim. Chang. 2016; 6: 42-50). Current atmospheric CO₂ and other greenhouse gas concentrations are already at dangerous levels, so even a drastic reduction in greenhouse gas emissions would merely curtail further increases, not reduce atmospheric greenhouse gas concentrations to safe levels. Moreover, the reduction or elimination of certain greenhouse gas sources (e.g., emissions from long distance airliners) would be extremely disruptive and/or expensive and are therefore unlikely to occur soon.

Therefore, there is a need to supplement emission reductions with the deployment of NETs, which are systems/processes that serve to reduce existing atmospheric greenhouse gas concentrations by, for example, capturing/removing CO₂ from the air and sequestering it for at least 1,000 years. The need for NETs may be explained using a bathtub analogy in which atmospheric CO₂ is represented by water contained in a bathtub, ongoing CO₂ emissions are represented by water flowing into the tub, and NETs are represented by processes that control water outflow through the tub's drain. In this analogy, reduced CO₂ emission rates are represented by partially turning off the water inflow tap—the slower inflow rate provides more time before the tub fills, but the tub's water level will continue to rise and eventually overflow. Using this analogy, although reducing CO₂ emissions may slow the increase of greenhouse gas in the atmosphere, critical concentration levels will eventually be reached unless NETs are implemented that can offset the reduced CO₂ emission level (i.e., remove atmospheric CO₂ at the same rate it is being emitted). Moreover, because greenhouse gas concentrations are already at dangerous levels (i.e., the tub is already dangerously full), there is an urgent need for NETs that are capable of significantly reducing atmospheric CO₂ faster than it is being emitted to achieve safe atmospheric concentration levels (i.e., outflow from the tub's drain must be greater than the reduced inflow from the tap to reduce the tub's water to a safe level).

NETs can be broadly characterized as Direct Air Capture (DAC) approaches and Ocean Capture approaches. DAC approaches utilize natural (e.g., reforestation) and technology-based methods to extract CO₂ directly from the atmosphere. Ocean capture approaches utilize various natural and/or technological processes to remove CO₂ from the atmosphere and store it in the ocean as bicarbonate, a form of carbon storage that is stable for over 10,000 years.

Electrochemical ocean alkalinity enhancement (OAE) represents an especially promising ocean capture approach that both reduces atmospheric CO₂ and mitigates ocean acidification by generating an ocean alkalinity product (i.e., an aqueous alkaline solution containing a fully dissolved base substance) and supplying the ocean alkalinity product to ocean seawater at a designated outfall location. OAE systems typically generate the required base substance using a bipolar electrodialysis device (BPED), which generally includes an ion exchange (IE) stack that performs an electrochemical salt-conversion process to convert salt supplied in an aqueous salt feedstock solution into the base substance and an acid substance. The base substance produced by the BPED is then incorporated into the ocean alkalinity product that is then supplied to the ocean. As the base substance diffuses (disperses) into the surrounding seawater it serves to directly reverse ocean acidification (i.e., by utilizing the base substance in the ocean alkalinity product to increases the ocean seawater's alkalinity), and indirectly reduces atmospheric CO₂ (i.e., increasing the ocean seawater's alkalinity increases the ocean's ability to absorb/capture atmospheric CO₂). Moreover, because the generated base substance is fully dissolved in the ocean alkalinity product, the electrochemical OAE approach avoids problems associated with other OAE approaches (e.g., dissolution kinetics issues that are associated with conventional mineral OAE approaches).

Although electrochemical OAE approaches show great potential in mankind's efforts to combat global warming and ocean acidification, their widespread acceptance as a suitable NET may be predicated on the continued development of OAE system features that minimize cost per unit of captured/removed atmospheric CO₂ (LCOC). For economic reasons related to carbon offsets and trading, NETs having relatively low LCOC ratings are typically favored over NETs exhibiting relatively high LCOCs. When calculating a NET's LCOC rating, many factors are taken into consideration, including capital costs (e.g., construction and installation expenses), and ongoing operating costs (e.g., land, water, maintenance, and electrical power expenses). In the case of OAE systems, the amount of atmospheric carbon removed from the atmosphere over an ocean depends on the amount of base substance supplied to the ocean (i.e., by way of the ocean alkalinity product), whereby the LCOC of an OAE system is predominantly determined by its levelized cost of producing each unit of base substance. In terms of the capital cost components of LCOC, OAE systems have an advantage over many NETs in that OAE systems are relatively inexpensive to construct and install, have a relatively small footprint and can be controlled using automated operating systems. Moreover, due to the high energy consumption and wear-related part replacement costs associated with performing the electrochemical salt-conversion process (described above), the most significant operating costs associated with an OAE system arise in the operation of the OAE system's BPED. Therefore, developments that reduce BPED operating costs arguably provide the most promising way to reduce OAE system LCOC.

The BPEDs currently utilized in OAE systems are referred to herein as 3-chamber BPEDs for brevity. Such 3-chamber BPEDs may be characterized by utilizing electrodialysis apparatuses having IE stacks configured with a 3-chamber arrangement, and by utilizing a flow control system capable of flowing three different aqueous solutions (i.e., a salt feedstock solution, an acid solution, and a base solution) through corresponding salt/acid/base chambers of the IE stack. The IE stack includes multiple cells arranged in series between opposing electrodes, where each cell includes three chambers that respectively serve as parallel flow channels for the aqueous salt, acid and base solutions as they pass through the IE stack (i.e., each cell includes a salt chamber that channels a portion of the salt feedstock solution, an acid chamber that channels a portion of the aqueous acid solution, and a salt/base chamber that channels a portion of the base solution). Each cell's salt chamber is disposed between and separated from the cell's acid and salt/base chambers by corresponding ion exchange membranes, which are configured to facilitate the transfer of sodium and chloride ions from the salt chamber into the base and acid chambers during the electrochemical process. That is, during the electrochemical process an electric field applied across the IE stack by the electrodes produces an ionic current in a direction perpendicular to the parallel flow paths, whereby anions in the salt/base/acid streams (e.g., chloride ions (Cl⁻) and hydroxide ions (OH⁻)) move toward the positive electrode (anode) and cations in the salt/base/acid streams (e.g., sodium ions (Na⁺) and protons (H⁺)) move toward the positive electrode (anode). This ionic current causes dissociated salt molecules (i.e., sodium ions (Na⁺) and chloride ions (Cl⁻)) to exit the salt feedstock stream in opposite directions (i.e., such that the chloride ions (Cl⁻) pass through a first ion exchange filter from the cell's salt chamber into the cell's acid chamber, and the sodium ions (Na⁺) pass through a second ion exchange filter into the cell's acid chamber). The chloride ions (Cl⁻) then combine with protons (H⁺) to form “new” acid (HCl) molecules in the acid solution stream passing through each cell's acid chamber, and the sodium ions (Na⁺) combine with hydroxide ions (OH⁻) to form “new” base (NaOH) molecules in the base solution stream passing through each cell's salt/base chamber. As a result of this electrochemical salt-conversion process, the base solution exiting the IE stack, which combines the base solution flows exiting each of the cells, has a significantly higher concentration of base substance than before entering the IE stack. Similarly, the acid solution exiting each cell has a higher concentration of acid substance than before entering the IE stack. That is, the 3-chamber IE stack arrangement is configured such that three separate streams exit the ED apparatus: a depleted salt solution stream (i.e., having a lower salt content than the salt feedstock solution fed into the ED apparatus), an acid product (strong acid) stream including the “new” acid molecules, and a base product (strong base) stream including the “new” base molecules.

The main operational costs associated with 3-chamber BPEDs include the cost of externally supplied electricity and maintenance (e.g., replacement part and manual labor) associated with the IE stack, flow control system and other BPED subsystems required to perform the electrochemical salt-conversion process. A majority of the externally supplied electricity needed to power a given BPED operations is consumed by the IE stack (i.e., to generate the electric field that produces the ionic current) and varies in accordance with the BPED's IE stack arrangement. That is, larger capacity IE stacks (i.e., those capable of generating larger amounts of base substance per hour) typically require a larger number of series-connected cells. Although the salt/acid/base solutions are conductive, each ion exchange membranes functions like a resistor that impedes the applied electric field. Therefore, larger capacity IE stacks require larger amounts of externally supplied electricity to maintain an electric field at a suitably strong level across a larger number of cells (i.e., across a larger number of ion exchange membranes) than that required by smaller capacity IE stacks. Moreover, a significant amount is needed to power the flow control system (e.g., the various pumps and valves required to maintain the pressures and flow rates of the salt/acid/base solution streams) and other BPED subsystems, such as feedstock pretreatment units that are typically utilized to remove solids and other contaminants (e.g., divalent ions) from the aqueous salt feedstock solution (e.g., seawater) in order to reduce fouling (e.g., mineral scaling) in the IE stack. BPED maintenance costs include the cost of replacing parts that periodically wear out during normal BPED operations, costs associated with service/labor required to replace these parts, and costs associated with maintenance-related down-time (i.e., the periods of OAE system non-operation that are required to perform maintenance operations). Similar to the cost of externally supplied electricity, maintenance costs are typically higher for BPEDs with larger capacity IE stacks than BPEDs with lower capacity IE stacks due to the need to periodically replace a greater number of expensive ion exchange membranes and the higher expense associated with the replacement of flow control system and pretreatment unit components capable of the required higher flow capacities. Because the effectiveness of OAE systems as a NET is strongly dependent on minimizing LCOC (i.e., minimizing the levelized cost of producing base substance), and because the cost of externally supplied electricity and maintenance costs (e.g., the cost of ion exchange filters/membrane replacement) represent two of the most significant expenses associated with an OAE system's production of base substance, there is a strong motivation to optimize OAE system operations in a way that minimizes these two cost components.

What is needed is a system/method that reduces OAE system LCOC by way of significantly reducing OAE system operating costs (i.e., external electricity and/or maintenance) over those of OAE system using 3-chamber BPEDs. For example, a modified BPED that significantly reduces the complexity and associated maintenance cost associated with either the flow control system or the pretreatment unit of a 3-chamber BPED would significantly reduce OAE system operational costs (e.g., by reducing one or both of maintenance costs and the cost of externally supplied electrical power), which in turn would significantly reduce an OAE systems' LCOC by reducing unit base substance production costs. These improvements could also be utilized to reduce operating costs in other systems that produce base and/or acid substances for commercial purposes.

### SUMMARY OF INVENTION

In an embodiment the present invention is directed to a method for removing divalent ions (e.g., Ca²⁺ and Mg²⁺) from an aqueous salt feedstock solution (e.g., seawater) before salt (e.g., NaCl) provided in the aqueous salt feedstock solution is processed by an electrochemical reactor to generate both an acid product/substance (e.g., HCl disposed in an acid product stream) and a base product/substance (e.g., NaOH disposed in a base product stream). The method generally involves utilizing a portion of the electrochemical reactor's base product (e.g., NaOH) to increase a pH level of the aqueous salt feedstock solution above a precipitation level of at least some of the divalent ions, thereby causing the precipitated divalent ions to form insoluble solids (e.g., CaCO₃, Ca(OH)₂, MgCO₃ and/or Mg(OH)₂) that may be separated/removed from the remaining supernatant solution (i.e., the mixture of base product and residual aqueous salt feedstock solution). The supernatant (aqueous salt/base) solution is then supplied to the electrochemical reactor for conversion of its salt into additional acid and base product. In an embodiment the method includes mixing a slipstream (feedback) portion of the base product stream exiting the electrochemical reactor with a corresponding amount of the aqueous salt feedstock solution to generate a process solution (mixture) having a pH level that is above a selected divalent precipitation level (e.g., above 12.5), thereby causing at least some of the divalent ions to precipitate in the form of insoluble solids. These precipitated insoluble solids are then separated/removed from the supernatant (i.e., the residual process solution) using known techniques (e.g., using a solids removing mechanism/separator), thereby producing a substantially divalent-ion-free aqueous salt/base solution that is then transmitted to the electrochemical reactor for electrochemical processing. These divalent ion removal methods are particularly useful in OAE systems and other systems that utilize an electrochemical reactor (e.g., a bipolar electrodialysis system (BPED)) to generate base and/or acid substances because increasing the feedstock solution pH above an effective divalent ion precipitation level can be achieved using only a small percentage (e.g., in the range of 0.1 to 5%) of the base (alkaline) product stream generated by the electrochemical reactor, whereby a majority portion of the base product stream remains available for ocean alkalinity enhancement (OAE), carbon capture or other beneficial purposes. Moreover, utilizing the base product portion to remove divalent ions from the aqueous salt feedstock solution provides several cost-reducing benefits over conventional divalent ion removal approaches. First, removing divalent ions before supplying the aqueous salt/base solution to the electrochemical reactor greatly reduces the buildup of depositions (scaling) inside the reactor's ion exchange (IE) stack, thereby reducing the need for frequent maintenance interventions (e.g., periodically suspending base production operations to perform descaling operations), and thus reducing an OAE system's operational costs by increasing the system's base production operating time (i.e., in comparison to conventional divalent ion removal approaches). Second, the proposed divalent ion removal approach can be implemented using substantially less complex (and, hence, less expensive) flow control system components than systems configured to remove divalent ions using conventional pretreatment approaches, thereby further reducing operating expenses over conventional divalent ion removal approaches that rely on conventional pretreatment techniques. Third, by facilitating the removal of divalent ions in solid form, the proposed divalent ion removal approach reduces overall system water demands (i.e., in comparison to conventional divalent ion removal approaches in which feedstock solution rejection rates can be as high as 75%). This means that, when the proposed divalent ion removal approach is utilized to process an industry's brine byproduct in remote inland locations (e.g., where seawater or ground water may not be readily available), substantially more of the submitted brine is consumed (less brine is rejected) than is achievable using conventional methods, thereby increasing throughput and, as a result, reducing the amount of time (and associated operating expense) required to fully process the brine byproduct. Fourth, because different solids (e.g., Mg(OH)₂ and CaCO₃) precipitate at different pH thresholds, the proposed divalent ion removal approach facilitates the separate (i.e., one-at-a-time) production of insoluble solids for OAE or other beneficial purposes by incrementally increasing the seawater's pH (as explained in further detail below).

In an embodiment, an OAE (or other) system utilizes a chemical precipitator and an associated control system to generate the aqueous salt/base solution that is transmitted to and processed by the electrochemical reactor. The chemical precipitator comprises one or more reactors, where each reactor including a reactor housing that defines (surrounds) an associated reaction chamber and is configured to receive and contain at least a portion of the process solution. Each reactor also includes a solution outlet device that is operably connected to its associated reactor housing and configured to remove salt/acid solution (i.e., partially or fully processed aqueous salt/base solution) from its associated reaction chamber for transmission either to a downstream reactor or to the electrochemical reactor (e.g., by way of an intervening buffer tank). Utilizing one or more reactors configured in this manner facilitates the generation of aqueous salt/base solution using various processes, such as batch-type processes (e.g., removing all divalent ions from a fixed volume of seawater contained within a single reactor) or continuous processes (e.g., gradually removing divalent ions as the process solution is passed through two or more series-connected reactors).

In some embodiments, each reactor housing includes a conical side wall portion that tapers to a relatively narrow lower outlet opening adjacent to the lower end of the reactor. This arrangement facilitates the removal of relatively high-density insoluble solids that sink to the bottom of the process solution, whereby these solids are guided by the conical side wall portion through the relatively narrow outlet opening and into a solids removal mechanism, which is operably configured to expel the insoluble solids through an outlet. Other reactor housing shapes may be utilized, for example, in cases where low-density insoluble solids float to the top of the process solution.

In an exemplary embodiment, the solids removal mechanism comprises a motor-driven feed screw that is rotatably disposed in a feed pipe and configured to impel insoluble solids toward/through an outlet end opening of the feed pipe. This arrangement facilitates the efficient removal of relatively high-density insoluble solids that sink to the bottom of the process solution. Other solids separating techniques (e.g., centrifuge-type separators) may be utilized, for example, in cases where insoluble solids exhibit neutral buoyancy.

In some embodiments, the solution outlet device comprises a T-shaped-pipe mounted to the side wall of the reactor housing and is configured to transmit the residual process solution (supernatant) from a central region of the process chamber (i.e., from a region of the process solution from which at least some of the divalent ions have been chemically removed). This arrangement facilitates the efficient separation of supernatant when some of the insoluble solids sink to the bottom of the process solution and some of the insoluble solids float to the top of the process solution. Other solution outlet devices may be utilized, for example, in cases where all insoluble solids either sink or float.

In other embodiments, the insoluble solids and the salt/base solution are separated and removed from the reactor using any known solid/liquid separation technique, such as those utilized by one or more of the following system types: Gravity settlers (e.g., clarifiers, deep thickeners, lamella separators, settling tanks, lagoons, thickeners), Sedimenting centrifuges (e.g., tubular bowl, skimmer pipe, disc, scroll discharge), Hydrocyclones (e.g., conical, circulating bed), Classifiers (e.g., hydraulic, mechanical, screens, sieve bends), Gravity filters (e.g., deep bed, Nutsche), Line filters (e.g., cartridges, strainers), Pressure filters (e.g., continuous pressure, diatomaceous earth, fiber bed, filter press, horizontal element, pressure Nutsche, vertical element, sand, sheet filter, tubular element), Filters with compression (e.g., belt press, membrane plate and frame, screw press, variable volume filter), Vacuum filters (e.g., top/bottom fed drum, disc, leaf, belt, pan, table, precoat drum), Filter thickeners or crossflow filters (e.g., delayed cake, dynamic or high shear microfilters, low shear microfilters/ultrafilters), Filtering centrifuges (e.g., basket, pendulum, oscillating, tumbling, plough/peeler, pusher, worm screen), Flotation, and Magnetic filters (e.g., low gradient (drum, grid or belt), or high gradient).

In some embodiments, the control system utilized to control operation of the chemical precipitator is configured to control the relative amounts of the base product stream and the aqueous salt feedstock solution transmitted into the reaction chamber of each reactor such that a pH of the process solution in each reactor is maintained at a target divalent precipitation pH level (i.e., at a pH level that causes at least some of the divalent ions provided with the feedstock solution to precipitate from the process solution and form corresponding insoluble solids. In some exemplary embodiments, the control system includes: one or more pH sensors configured to measure the pH of the process solution disposed in each reaction chamber, o te/transmit flow rate control signals to each flow control device such that the pH of the process solution in each reactor chamber is maintained at an associated target divalent precipitation pH level. Controller can be an electronic device (e.g., a computer/processor or dedicated electronic device) that implements software-based instructions or is otherwise configured to execute various system-related software-based programs including the chemical precipitator control method described herein. In some embodiments controller also controls the operations performed by the electrochemical reactor (e.g., in the manner described in co-owned U.S. Pat. No. 11,629,067, entitled “OCEAN ALKALINITY SYSTEM AND METHOD FOR CAPTURING ATMOSPHERIC CARBON DIOXIDE”, which is incorporated herein by reference in its entirety).

In some embodiments the chemical precipitator is configured to separately produce one or more targeted (selected) insoluble solid types during the divalent ion removal process, whereby the targeted/selected insoluble solid(s) are efficiently separately from other insoluble solids (i.e., such that additional processing is not needed to separate the selected insoluble solids after completing the divalent ion removal process, which may be necessary if all divalent ions were removed using a single reactor). In one embodiment such chemical precipitators include two or more series-connected reactors that respectively contain portions of the process solution, where each portion is maintained by the control system at a corresponding (different) target divalent precipitation pH level in order to generate associated selected insoluble solids. For example, the control system may be configured such that the process solution portion contained in one of the series-connected reactor is maintained at a pH level of 11 in order to generate a first associated target insoluble solid (e.g., Mg(OH)₂), and further configured such that the process solution portion contained in a second (downstream) series-connected reactor is maintained at a pH level of 12.3 in order to generate a second associated target insoluble solid (e.g., CaCO₃), and so on. In an exemplary configuration, three series-connected reactors are arranged such that a first (e.g., most upstream) reactor receives the aqueous salt feedstock solution and a first part of the base product slipstream (first base product slipstream portion), a second (next-downstream) reactor receives partially processed solution (first overflow portion) from the first reactor and a second part of the base product slipstream, and a third (e.g., last, most-downstream) reactor receives partially processed solution (second overflow portion) from the second reactor and a third part of the base product slipstream. The control system utilizes sensors and flow control devices (e.g., using the techniques described above) to maintain the process solution portions contained in each of the series connected reactors at a selected (different) target divalent precipitation pH level (e.g., pH11, pH12.3 and pH13, respectively) such that each of the series connected reactors produces a corresponding selected (different) target insoluble solid (e.g., Mg(OH)₂, CaCO₃ and Ca(OH)₂, respectively). An advantage provided by this multiple series-connected reactor configuration is that one or more of the separately produced target insoluble solids (e.g., Mg(OH)₂ and/or Ca(OH)₂) are immediately available for OAE purposes (e.g., mixed with seawater or utilized for direct air capture), or may be sold for use in other processes, thus further reducing the LCOC of an OAE system implementing the chemical precipitator 190A1 described above.

Another advantage provided by the proposed divalent ion removal approach (described above) is that the generation of aqueous salt/base solution facilitates the use of electrochemical reactors that utilize a 2-chamber ion exchange (IE) stack arrangement capable of generating the acid and base product streams at a lower cost (i.e., in comparison to 3-chamber BPEDs or other electrochemical reactors utilizing a conventional 3-chamber IE stack arrangement). As explained above, conventional electrochemical reactors (e.g., 3-chamber BPEDs) typically utilize ED apparatuses that employ a 3-chamber IE stack arrangement in which each cell includes three chambers and two intervening ion exchange membranes, and require flow control systems capable of directing three separate aqueous solution streams through the ED apparatus (i.e., a salt feedstock stream that supplies salt to the ED apparatus for conversion, an acid solution stream that carries away the generated acid molecules, and a base solution stream that carries away the generated base molecules). The proposed 2-chamber IE stack arrangement is similar to the 3-chamber approach in that it includes one or more cells disposed between opposing electrodes, but in the 2-chamber IE stack arrangement each cell includes only two chambers (i.e., an acid (first) chamber and a salt/base (second) chamber) separated by a single intervening ion exchange membrane (e.g., an anion exchange membrane (AEM) or a cation exchange membrane (CEM)) that are disposed between two bipolar membranes. In addition, the flow control system utilized by the 2-chamber IE stack arrangement is required to direct only two solution streams through the ED apparatus (i.e., instead of the three separate streams required by the 3-chamber approach). Specifically, the flow control system used by the 2-chamber IE stack arrangement is required to direct an acid stream and a salt/base stream through the ED apparatus, where the acid stream is formed by a relatively weak aqueous acid solution that is directed into the acid chambers of the IE stack and the relatively strong acid product stream exiting the acid chambers of the IE stack, and the salt/base stream is formed by the relatively low pH (weak base) aqueous salt/base solution, which is directed into the salt/base chambers of the IE stack, and the relatively strong base product stream exiting the salt/base chambers of the IE stack. In an exemplary embodiment the relatively low pH of the aqueous salt/base solution directed into the salt/base chambers is at a selected divalent ion precipitation level (e.g., a pH level of 12.5), and the relatively strong base product stream exiting the salt/base chambers has a pH level above 13.5. During the electrochemical process performed using this 2-chamber IE stack arrangement, dissociated salt molecules disposed in the aqueous salt/base solution are processed (by way of an electric field generated between the electrodes) such that the sodium ions (Na⁺) remain in the salt/base chamber and the chloride ions (Cl⁻) pass through the intervening ion exchange membrane from the salt/base chamber into the acid chamber. In addition, water molecules (H₂O) are dissociated by the bipolar membranes, and the resulting dissociated protons (H⁺) and hydroxide ions (OH⁻) are respectively directed by the electric field into the acid chamber and the salt/base chamber. These processes allow the sodium ions (Na⁺) remaining in the salt/base chamber of each cell combine with dissociated hydroxide ions (OH⁻) to generate new base molecules (NaOH) in the salt/base stream, thereby increasing the base strength (increasing the pH level) of the base product stream exiting the salt/base chambers, and allow the chloride ions (Cl⁻) passing through the intervening ion exchange membrane combine with dissociated protons (H⁺) disposed in the acid chamber to generate new acid molecules (HCl) in the acid stream, thereby increasing the acid strength (decreasing the pH level) of the acid product stream exiting the acid chambers. Although utilizing the proposed divalent ion removal approach in conjunction with this 3-chamber IE stack arrangement (e.g., by directing the aqueous salt/base solution through both the salt chamber and the salt/base chamber) may achieve at least some of the benefits (mentioned above), utilizing the proposed divalent ion removal approach in conjunction with the proposed 2-chamber IE stack arrangement provides several additional cost-reducing benefits. First, the 2-chamber IE stack arrangement requires only two ion exchange membranes per cell (i.e., per each pair of acid and salt/base chambers), which represents a part reduction of 20 to 40% over the three membranes per cell required by conventional 3-chamber IE stack arrangements. Because the cost of ion exchange membranes represents a majority of the overall IE stack cost, reducing the number membranes from three to two significantly reduces the IE stack production costs. Moreover, because ion exchange membranes must be periodically replaced, reducing the number membranes significantly reduces operational costs over an OAE system's lifetime. Second, reducing the number of ion exchange membranes per cell produces a substantially 33% reduction in area-specific ohmic resistance (ASR) of each 2-chamber IE stack (i.e., in comparison to comparable 3-chamber IE stacks), thereby reducing the amount of voltage required to pass a given amount of current through the IE stack, and thus reducing operating costs (e.g., reducing the unit cost of base product by reducing the amount/cost of externally supplied electrical power) and decreasing the OAE system's carbon footprint. Third, combining the salt and base process streams significantly reduces the cost and complexity of the associated fluid control system required to perform the 2-chamber IE stack approach (i.e., reducing the number of process fluid streams directed through the IE stack from three to two produces a 33% reduction in the number of pipes, stack connections, and fluid flow/pressure regulation devices, along with the associated footprint required for this equipment).

In some embodiments the ED apparatus includes an ion exchange stack made up of acid chambers and salt/base chambers that are disposed in an alternating arrangement between an anode and a cathode and separated by intervening ion exchange/bipolar membranes. The alternating chamber arrangement is configured such that, each centrally located acid chamber is disposed between two (first and second) salt/base chambers, and each of the centrally located salt/base chamber is disposed between two (first and second) acid chambers. The acid chambers and salt/base chambers form parallel flow paths for the aqueous salt/base solution and salt/base chambers, which are divided such that a portion of the aqueous salt/base solution is directed through each of the salt/base chambers and such that a portion of the aqueous acid solution is directed through each of the acid chambers. The parallel flow channels are arranged such that, when a suitable stack voltage is applied across the anode and the cathode, the resulting electric field (driving force) induces faradaic reactions on the electrodes that drive an ionic current between the anode and the cathode (i.e., generally perpendicular to the flow path direction) passes through all components of the ion exchange stack (i.e., the acid chambers, the salt/base chambers, the ion exchange membranes and the bipolar membranes. In some embodiments the intervening ion exchange/bipolar membranes are arranged in an alternating pattern between the alternating acid chambers and salt/base chambers. That is, each centrally located acid chamber is separated from a (first) adjacent salt/base chamber by an associated anion exchange membrane and is separated from a (second) adjacent salt/base chamber by an associated bipolar membrane. Similarly, each centrally located salt/base chamber is separated from a (first) adjacent acid chamber by an associated bipolar membrane and is separated from a (second) adjacent acid chamber by an associated anion exchange. By configuring the IE stack with alternating the acid and salt/base channels and alternating anion exchange and bipolar membranes as described above, the IE stack is able to generate separate acid substance and base product streams with substantially higher energy efficiency than 3-chamber approaches.

In some embodiments the ED apparatus is configured such that the IE stack includes a series of two-chamber cells disposed between the anode and the cathode, where each cell includes an acid chamber and a salt/base chamber separated by an intervening anion (or cation) exchange membrane, and where adjacent cells are separated by an intervening bipolar membranes (i.e., such that the acid chamber and the salt/base chamber) of each cell are sandwiched between two bipolar membranes). The cells of the IE stack are separated from the anode and the cathode by oxidation-reduction (redox) chambers and associated membranes (e.g., anion/cation exchange or bipolar membranes), and the ED apparatus includes an electrolyte solution circulation system that is configured (e.g., including a reservoir, flow lines and a pump) to circulate an electrolyte solution (e.g., sodium sulfate or a semi conductive solution such as sodium hydroxide) through the redox chambers. That is, a first redox chamber is disposed between the cathode and a first “end” chamber of the series of cells, with a first membrane disposed between the first redox chamber and the first “end” chamber (i.e., such that the electrolyte solution is prevented from mixing with the acid solution portion disposed in the first “end” chamber). Similarly, a second redox chamber is disposed between the anode and a second “end” chamber, with a second membrane disposed to prevent mixing of the electrolyte solution disposed in the second redox chamber and salt/base solution flowing in the second “end” chamber. In some embodiments the ED apparatus utilizes an input manifold and an output manifold to facilitate the flow of acid and salt/base solutions through the IE stack. The input manifold is configured to receive the aqueous acid stream (e.g., from the acid buffer tank) and the aqueous salt/base solution generated by the chemical precipitator (e.g., from the optional salt/base buffer tank), and to divide (split) each stream such that a portion of the aqueous acid solution is directed into the acid chamber of each cell, and such that a portion of the aqueous salt/base solution is directed into the salt/base chamber of each cell. Similarly, the output manifold is configured to receive portions of the acid product stream (e.g., from the acid buffer tank) and the aqueous salt/base solution generated by the chemical precipitator (e.g., from the optional salt/base buffer tank), and to divide (split) each stream such that a portion of the aqueous acid solution is directed into the acid chamber of each cell, and such that a portion of the aqueous salt/base solution is directed into the salt/base chamber of each cell. By disposing a series of 2-chamber cells between redox chambers and utilizing manifolds to direct the acid and salt/base solution flows through the channels in this manner, the ED apparatus is able to generate separate acid substance and base product streams with substantially higher efficiency than is possible using 3-chamber approaches.

In an exemplary embodiment, an OAE system utilizes a BPED (electrochemical reactor) including a fluid buffering system, the ED apparatus described above, and a post-production subsystem. The fluid buffering system includes an acid buffer tank and an optional salt/base buffer tank. The acid buffer tank is utilized to generate and contain the aqueous acid solution by mixing a portion of the acid product stream (i.e., which is fed back from the IE stack) with either a portion of the salt feedstock solution or another dilutant (e.g., fresh or desalinated water), and is configured to supply the aqueous acid solution to the acid chamber(s) of the ED apparatus. The optional salt/base buffer tank is operably coupled to receive and store the aqueous salt/base solution generated by the chemical precipitator and is configured to supply the aqueous salt/base solution to the salt/base chamber(s) of the ED apparatus. The post-production subsystem is configured to generate an ocean alkalinity product using a second portion of the base product stream (i.e., the remainder of the base product stream exiting the IE stack that is not fed back to the chemical precipitator), and is further configured to supply (e.g., pump) the ocean alkalinity product into an ocean at a designated outfall location. In some embodiments the ocean alkalinity product is generated using a dilution apparatus configured to operate in the manner described in co-owned and co-pending U.S. patent application Ser. No. 18/131,839, entitled “PRODUCTION EFFICIENCY OPTIMIZATION FOR BIPOLAR ELECTRODIALYSIS DEVICE”, which was filed on Apr. 6, 2023 and is incorporated herein in its entirety. In some embodiments, the post-production subsystem also includes an acid neutralization device that is configured to receive and process a second portion of the acid product stream (i.e., the remainder of the acid product stream exiting the IE stack that is not fed back to the acid buffer tank), where the acid neutralization device operates in the manner described in U.S. patent application Ser. No. 18/131,839 (cited above).

In some embodiments an OAE system includes an alkaline solids processor that is configured to receive the alkaline solids generated by the chemical precipitator, and is configured to perform one of: (i) redissolving the insoluble solids (e.g., CaCO₃, Ca(OH)₂, MgCO₃ and/or Mg(OH)₂) in seawater using land-based containers (so dissolution can be directly measured in an efficient manner) and then returning the seawater (i.e., with the dissolved solids) to the ocean for OAE purposes (i.e., either after performing pre-equilibration or not); (ii) dispersing the insoluble solids into the ocean directly (near the shoreline or far offshore} for OAE; (iii) packaging the insoluble solids for resale to other entities (i.e., so the solids can be used to perform other commercial/useful purposes); and/or (iv) utilizing the insoluble solids as a direct air capture sorbent.

In some embodiments the system includes a feedstock pretreatment unit that is configured to remove solid contaminants from a raw salt feedstock solution (e.g., seawater or brine), and to supply the resulting aqueous salt feedstock solution to the chemical precipitator (and, optionally, also to an acid buffer tank). In some embodiments the pretreatment unit includes a first filtering system configured to remove solid particles from the seawater/brine (e.g., using a first filter), and a second filtering system configured to remove one or more of metals and biologic materials (e.g., using one or more second filters) from the filtered seawater/brine received from the first filtering system.

In some embodiments the same pretreated aqueous salt feedstock solution is directed by the flow control system to both the acid buffer tank and the chemical precipitator. That is, a first portion of the aqueous salt feedstock solution is transmitted (e.g., by way of a first pipe) from the pretreatment unit to the acid buffer tank, and a second portion of the aqueous salt feedstock solution is directed (e.g., by way of a second pipe) from the pretreatment unit to the chemical precipitator. Within the stack, some water molecules (H₂O) disposed in the two solutions are dissociated by the bipolar membranes, and the resulting dissociated protons (H⁺) and hydroxide ions (OH⁻) are respectively directed by the electric field into the adjacent acid chamber and the adjacent salt/base chamber.

In other embodiments the pretreatment unit further includes a reverse osmosis (RO) system that is configured to generate both an aqueous salt feedstock solution and a desalinated solution (i.e., such that the aqueous salt feedstock solution has a higher salt concentration that the desalinated solution). In this case the flow control system is further configured to direct (e.g., by way of a first pipe) the desalinated solution from the pretreatment unit to the acid buffer tank, and configured to direct (e.g., by way of a second pipe) the aqueous salt feedstock solution from the pretreatment unit to the chemical precipitator. This approach increases the salt concentration in the aqueous salt/base solution and effectively eliminates salt from the aqueous acid solution. In some cases the cost of including the RO system may be offset by the increased amount acid/base production due to the increased salt concentration in the salt/base solution.

### BRIEF DESCRIPTION OF THE DRAWINGS

FIG. 1 shows a simplified OAE system configured to implement a divalent ion removal process according to an embodiment of the present invention;

FIG. 2A shows a simplified chemical precipitator configured to remove divalent ions from an aqueous salt feedstock solution according to an embodiment;

FIG. 2B shows a simplified chemical precipitator configured to remove divalent ions from an aqueous salt feedstock solution according to another embodiment;

FIG. 3 shows a simplified electrochemical reactor (e.g., a BPED) configured to electrochemically process an aqueous salt/base solution according to another embodiment;

FIG. 4 shows a simplified electrodialysis apparatus including a 2-chamber ion exchange stack that is configured to electrochemically process an aqueous salt/base solution according to another embodiment;

FIG. 5A shows a simplified system according to another embodiment of the present invention;

FIG. 5B depicts an electrochemical process performed by the system of FIG. 5A;

FIG. 6A shows a simplified system according to another embodiment of the present invention; and

FIG. 6B depicts an electrochemical process performed by the system of FIG. 6A.

### DETAILED DESCRIPTION

The embodiments described herein relate to methods and systems for improving the operating efficiency of electrochemical reactors (e.g., bipolar electrodialysis devices) that are utilized to generate acid and base products by way of electrochemically converting salt provided in seawater, brine or another aqueous salt feedstock solution. The following description is presented to enable one of ordinary skill in the art to make and use the methods and systems described herein as provided in the context of specific embodiments. Various modifications to the embodiments will be apparent to those with skill in the art, and the general principles defined herein may be applied to other embodiments. Therefore, the methods and systems described herein are not intended to be limited to the particular embodiments shown and described but are to be accorded the widest scope consistent with the principles and novel features herein disclosed.

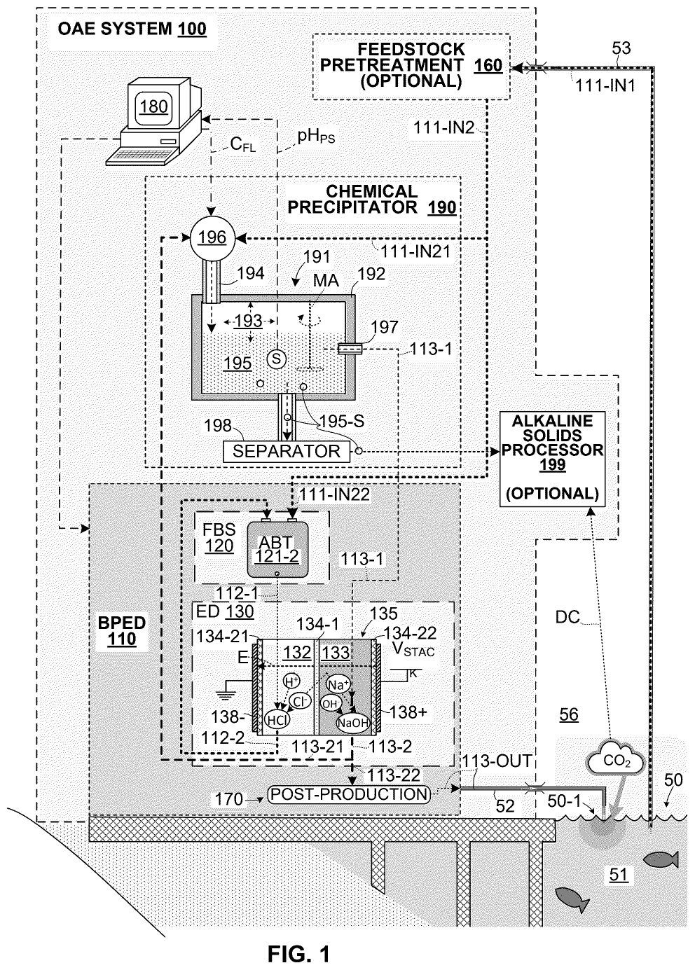

FIG. 1 shows an ocean alkalinity enhancement (OAE) system 100 including a BPED (electrochemical reactor) 110, a chemical precipitator 190 and control system including a controller 180 according to a generalized embodiment.

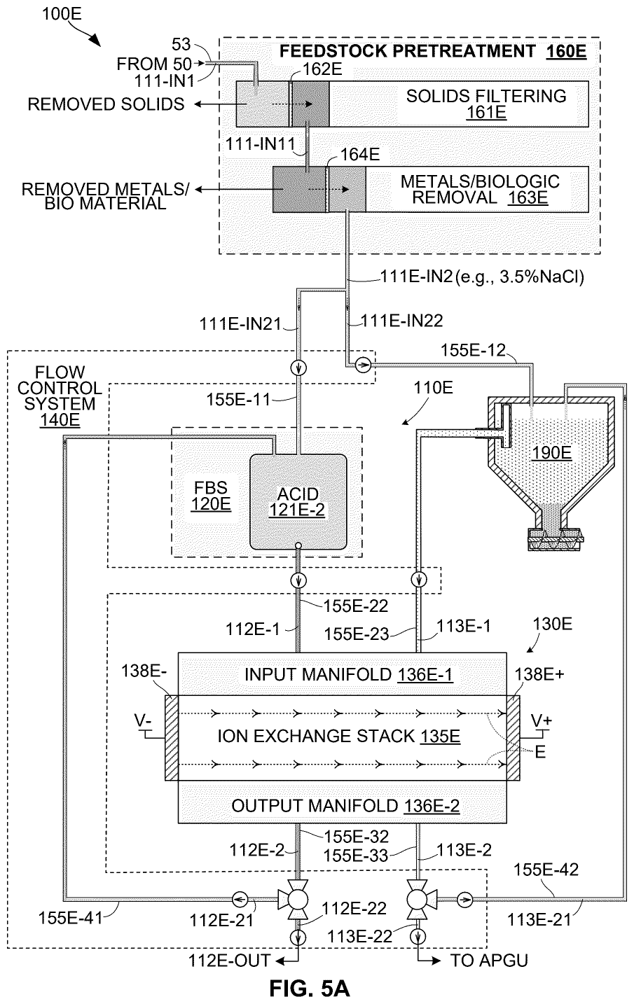

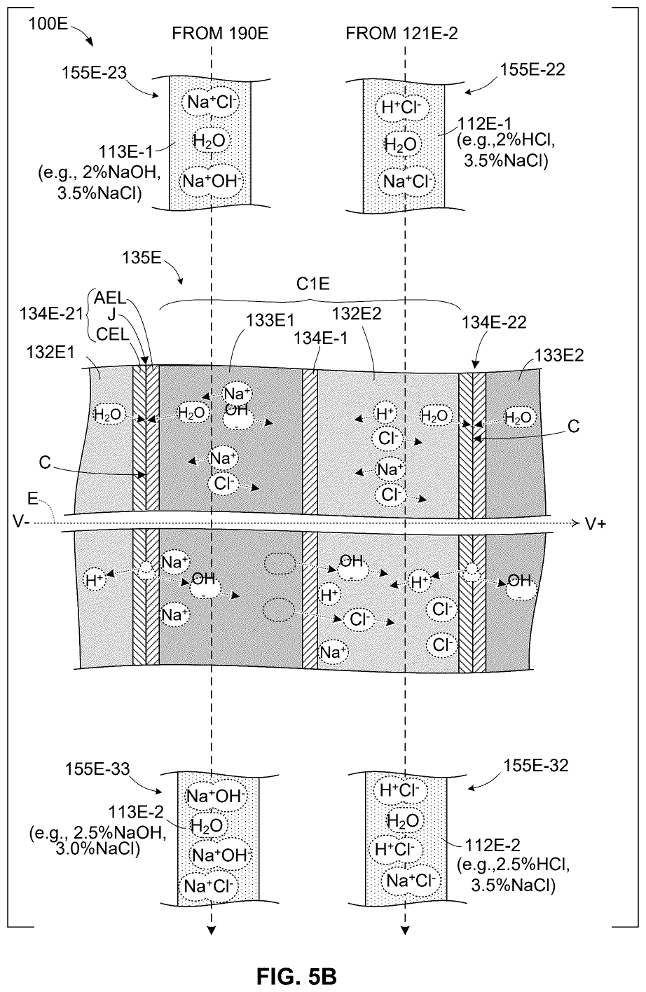

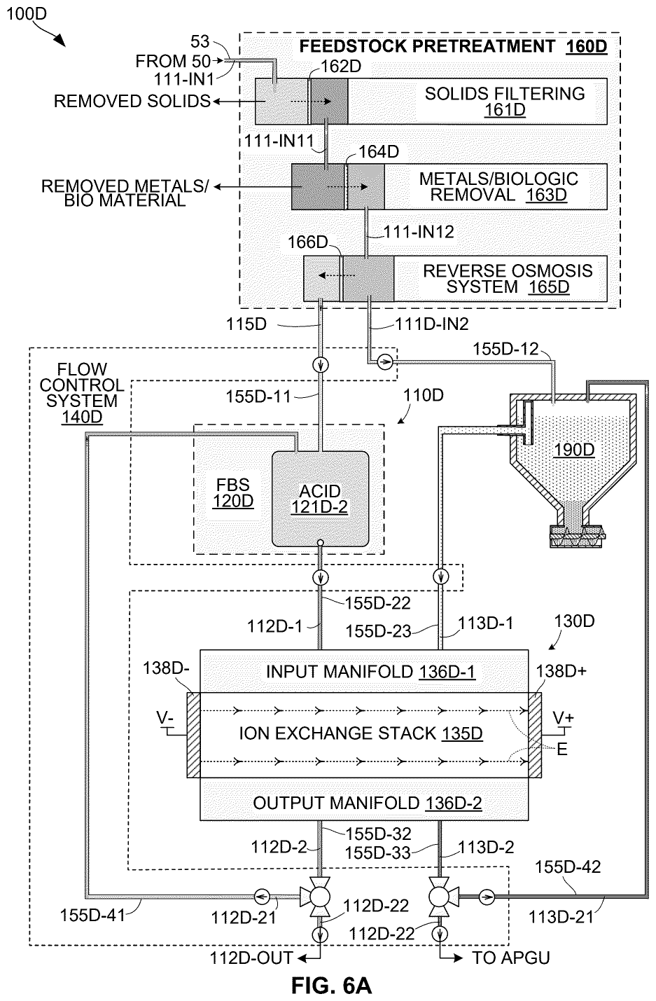

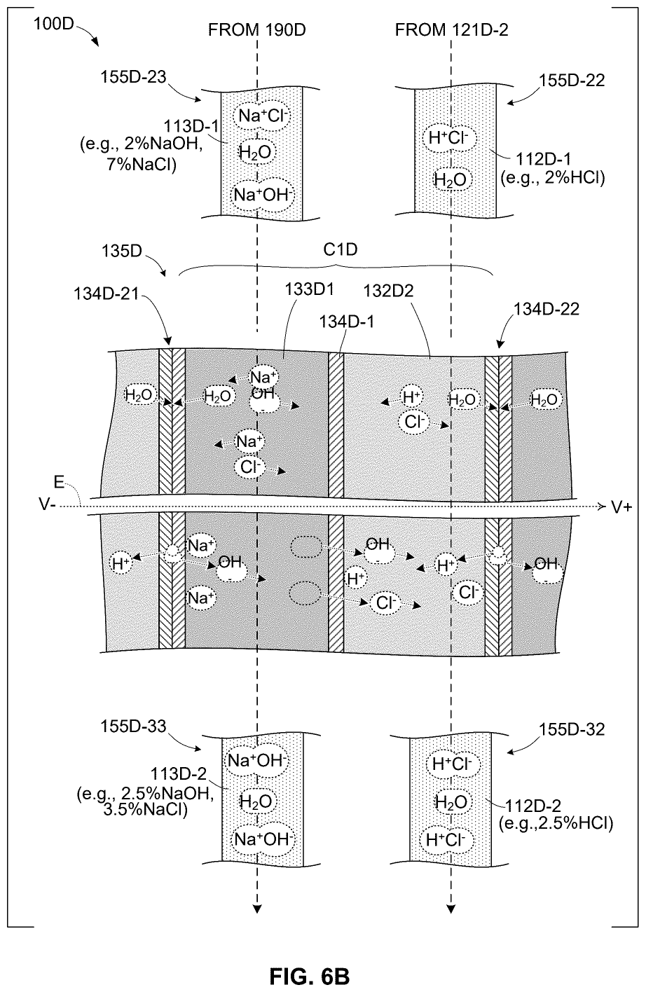

OAE system 100 receives a raw salt feedstock solution 111-IN1 (e.g., seawater 51 pumped from a nearby ocean 50 by way of a transfer-in pipe 53) that comprises water (H₂O), salt (NaCl), divalent ions (e.g., Ca²⁺ and Mg²⁺) and may contain solid contaminants (e.g., soil particles, metals, and/or biological materials). In other embodiments (not shown), raw salt feedstock solution 111-IN1 may comprise brine generated by a brine source (e.g., a desalination plant or a water recycling plant that processes seawater and generates brine as a byproduct). Referring to the upper portion of FIG. 1, an optional feedstock pretreatment unit 160 is configured to generate aqueous salt feedstock solution 111-IN2 by removing solid contaminants from raw salt feedstock solution 111-IN1. In some embodiments (e.g., such as that described below with reference to FIG. 5A) pretreatment unit 160 may be configured to supply a first portion 111-IN21 of the resulting (pretreated) aqueous salt feedstock solution 111-IN2 to chemical precipitator 190, and to supply a second portion 111-IN22 of pretreated feedstock solution 111-IN2 to BPED 110. In other embodiments (e.g., as described below with reference to FIG. 6A), feedstock pretreatment unit 160 is configured to generate aqueous salt feedstock solution 111-IN2 such that first feedstock solution portion 111-IN21 supplied to chemical precipitator 190 has a higher salt content than second feedstock solution portion 111-IN22 supplied to BPED 110. A benefit of utilizing pretreatment unit 160 is that the removal of solid contaminants reduces maintenance-related costs and downtime by reducing contaminant build-up in chemical precipitator 190 and BPED 110. In some embodiments (e.g., when raw feedstock solution 111IN-1 is sufficiently free of solid contaminants), it may be possible to eliminate feedstock pretreatment unit 160 (i.e., such that feedstock solution 111-IN2 supplied to chemical precipitator 190 has the same chemical composition as raw feedstock solution 111-IN1).

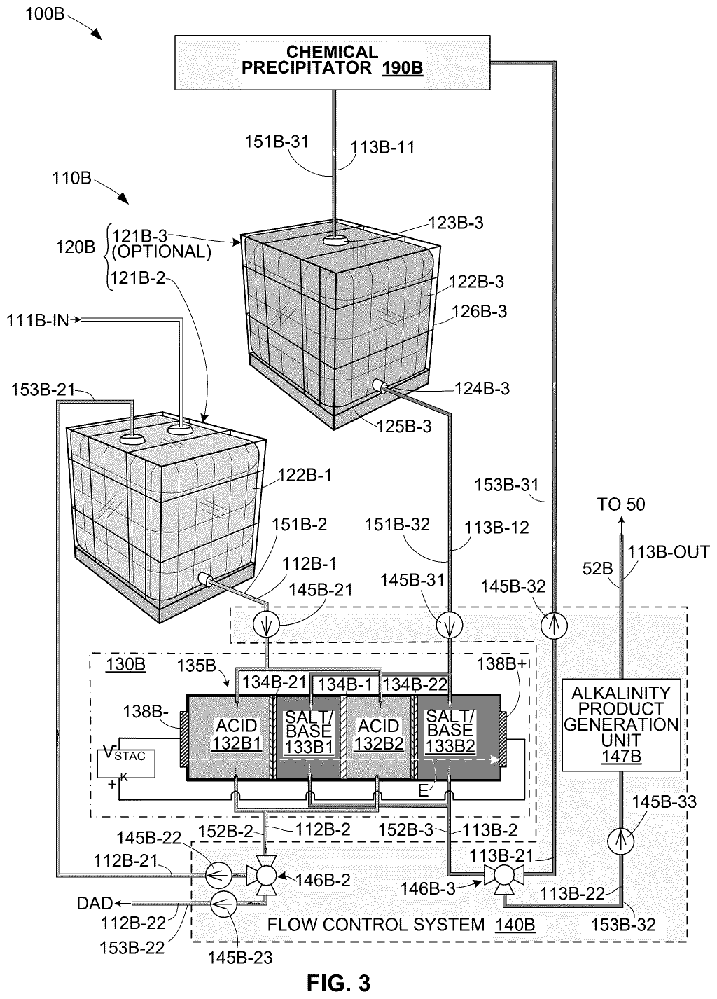

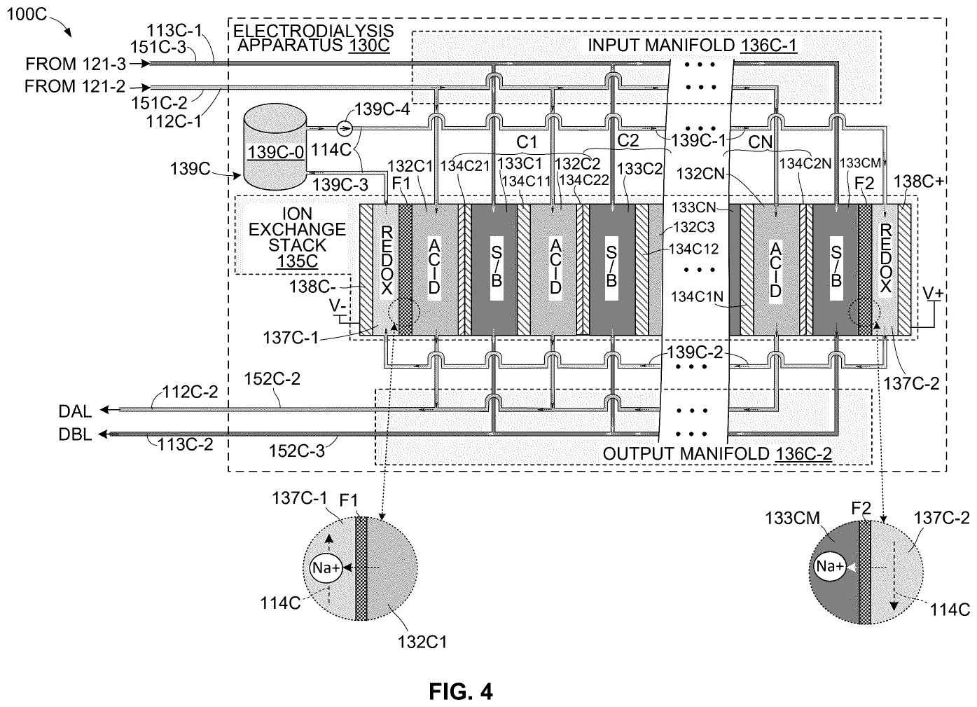

BPED (bipolar electrodialysis device) 110 receives feedstock solution portion 111-IN22 from feedstock pretreatment unit 160 and an aqueous salt/base solution 113-1 from chemical precipitator 190 and generates an acid product stream 112-2 including HCl (acid substance) and a base product stream 113-2 including fully dissolved NaOH (base substance) by electrochemically processing salt provided in aqueous salt/base solution 113-1. BPED 110 is configured such that acid product stream 112-2 and base product stream 113-2 comprise two separate streams (i.e., such that HCl may be harvested from acid product stream 112-2 and NaOH disposed in base product stream 113-2 may be utilized to generate an ocean alkalinity product 113-OUT that, when supplied to ocean 50, both reduces atmospheric carbon dioxide CO₂ in atmosphere 56 and mitigates ocean acidification in ocean seawater 51. In the exemplary embodiment, BPED 110 includes a fluid buffering system 120, an electrodialysis (ED) apparatus 130, and an associated flow control system configured to facilitate the various fluid flows. ED apparatus 130 includes an ion exchange stack 135 including at least one acid chamber 132 and at least one salt/base chamber 133 arranged in series between opposing electrodes 138+ and 138− and respectively separated by an intervening ion exchange membrane 134-1 (i.e., at least one of an anion exchange membrane or a cation exchange membrane) and sandwiched between two bipolar membranes 134-21 and 134-22. The flow control system includes associated devices (e.g., pipes and pumps) that are operably configured to direct at least a portion of aqueous acid solution 112-1 into acid chamber 132 and to direct acid product stream 112-2 away from acid chamber 132, and to direct aqueous salt/base solution 113-1 into salt/base chamber 133 and to direct base product stream 113-2 away from salt/base chamber 133. ED apparatus 130 is further configured such that, while a suitable electric field E across stack 135 by applying a voltage source V_{STACK} and ground respectively to anode 138+ and cathode 138−, as aqueous salt/base solution 113-1 passes through salt/base chamber 133, chloride ions Cl⁻ from at least some of the salt molecules disposed in aqueous salt/base solution 113-1 pass from salt/base chamber 133 through ion exchange membrane 134-1 into acid chamber 132, where they combine with hydrogen ions H⁺ to generate hydrochloric acid (HCl) molecules that exit stack 135 by way of acid product stream 112-2. In addition, sodium ions Na⁺ from at least some of the salt molecules disposed in aqueous salt/base solution 113-1 combine with hydroxide ions OH⁻ to form sodium hydroxide (NaOH) molecules that exit stack 135 by way of base product stream 113-2. Post-production subsystem 170 utilizes a second portion 113-22 of base product stream 113-2 to generate ocean alkalinity product 113-OUT, which is then supplied to ocean 50 at a designated outfall location 50-1 (e.g., by way of a transfer-out pipe 52. Additional details and features of BPED 110 and the electrochemical process are provided below, for example, with reference to FIGS. 3 and 4.

Chemical precipitator 190 receives first feedstock solution portion 111-IN21 from feedstock pretreatment unit 160 and a slipstream (first) portion 113-21 of base product stream 113-2 from BPED 110 and generates aqueous salt/base solution 113-1, which is supplied to BPED 110. As set forth in additional detail below, chemical precipitator 190 is controlled by controller 180 to generate a process solution 195 by intermixing a specific amount of slipstream portion 113-21 with a corresponding proportional amount of aqueous salt feedstock solution portion 111-IN21 in proportions that cause precipitation of divalent ions in the form of alkaline solids 195-S (e.g., CaCO₃, Ca(OH)₂, MgCO₃ and/or Mg(OH)₂). Note that aqueous salt feedstock solution portion 111-IN21 has a relatively low pH level and comprises H₂O (water), NaCl (salt) molecules and divalent ions (e.g., Ca²⁺ and Mg²⁺), and that slipstream portion 113-21 has a relatively high pH level due to the presence of NaOH (base substance) generated in BPED 110. Accordingly, a pH level of process solution 195 may be controlled (increased or decreased) by changing the relative amounts (e.g., inflow rates) of slipstream portion 113-21 and aqueous salt feedstock solution portion 111-IN21 in chemical precipitator 190. As also explained in additional detail below, the pH of process fluid 195 is controlled in a way that causes the precipitation of divalent ions (e.g., Ca²⁺ and Mg²⁺) in the form of insoluble solids 195-S, thereby facilitating the removal of divalent ions from process solution 195 (e.g., by way of a separator 198 configured to separate insoluble solids 195-S from the residual process solution 195). Note that aqueous salt/base solution 113-1, which is transmitted from chemical precipitator 190 to BPED 110 by way of pumps/pipes, comprises a portion of process solution 195 that includes the salt (e.g., NaCl) supplied by aqueous salt feedstock solution portion 111-IN21, but from which divalent ions have been precipitated/removed.

In the depicted embodiment, chemical precipitator 190 comprises a reactor 191 including a reactor housing 192, an inlet device 196, an outlet device 197 and solids removal mechanism 198. Reactor housing 192 surrounds a reaction chamber 193 in which base product slipstream portion 113-21 and aqueous salt feedstock solution portion 111-IN21 are mixed. An optional mixer/agitator MA (e.g., a rotating propeller-type blade) may be included inside reaction chamber 193 and configured to facilitate mixing of base product slipstream portion 113-21 and aqueous salt feedstock solution portion 111-IN21. Inlet device 196, which may also be considered part of the control system, is configured to facilitate the inflow of slipstream portion 113-21 and aqueous salt feedstock solution portion 111-IN21 into reaction chamber 193. Outlet device 197 is operably connected to reactor housing 192 and is configured to deliver aqueous salt/base solution 113-1 from reaction chamber 193 to BPED 110. Solids removal mechanism (separator) 198 is mounted to a lower portion of reactor housing 193 and is configured to remove insoluble solids 195-S that are generated by the precipitation of divalent ions in reaction chamber 193 (e.g., solids that sink to the bottom of process solution 195).

In some embodiments an alkaline solids processor 199 may be utilized to receive and process insoluble solids 195-S that have been removed from reactor housing 192 by way of separator 198. In some embodiments, alkaline solids processor 199 may be configured to perform one of: (i) redissolving insoluble solids 195-S in seawater using land-based containers (so dissolution can be directly measured) and then returning the seawater to ocean 50 for OAE (after pre-equilibration or not); (ii) dispersing insoluble solids 195-S in ocean 50 directly (near shore or far offshore} for OAE; (iii) packaging insoluble solids 195-S for resale to perform other useful purposes; and/or (iv) utilizing insoluble solids 195-S as an air capture sorbent (e.g., to directly capture atmospheric CO₂, as indicated by dot-line arrow DC in FIG. 1)).

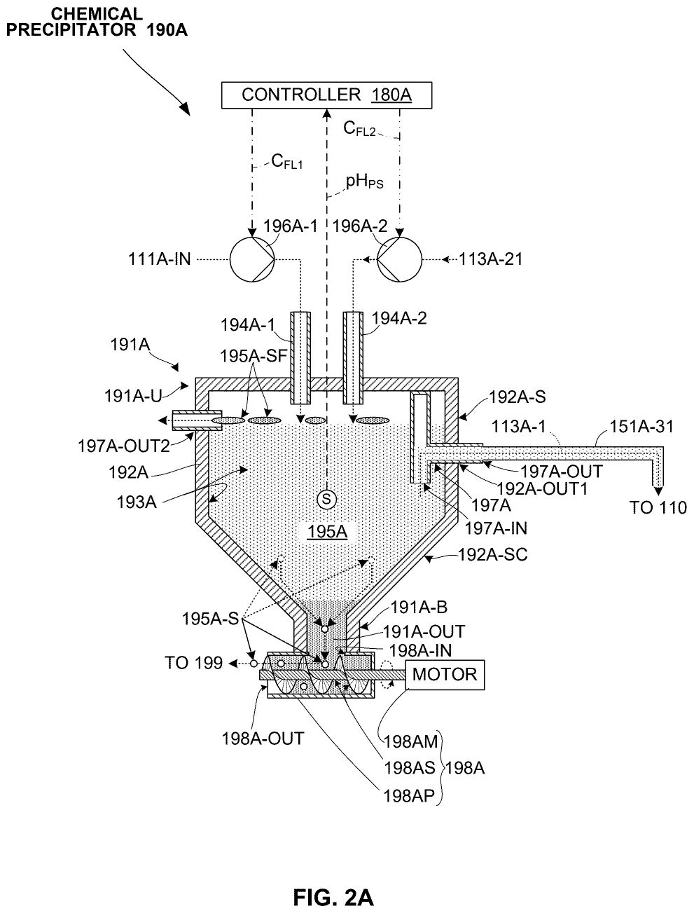

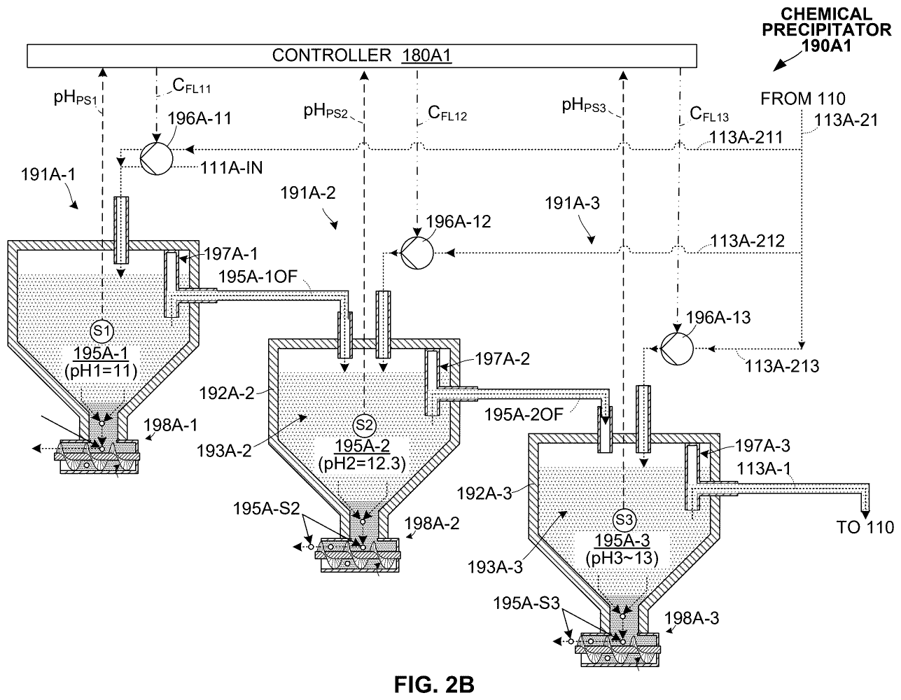

Additional details associated with chemical precipitator 190, such as specific reactor housing configurations, feedpipe-type separator mechanisms and output devices are described below, for example, with reference to FIGS. 2A and 2B.

The portion of the OAE control system that controls chemical precipitator 190 includes a sensor S, a flow control device 196 and a corresponding portion of controller 180. Sensor S is disposed in reaction chamber 193 and is configured to generate a process solution pH measurement signal pH_{PS} indicating a current (real time) pH level of process solution 195 disposed in reaction chamber 193. Flow control device (e.g., one or more dosing pumps) 196 is configured to control inflow rates of aqueous salt feedstock solution 111-IN1 and base product slipstream (first base product stream portion) 113-21 into reaction chamber 193 by way of inlet port 194. Controller 180 is configured to receive process solution pH measurement signal pH_{PS} and to transmit corresponding flow rate control signals C_{FL} to flow control device 196 such that the pH level of process solution 195 is maintained at the target divalent precipitation pH level. That is, the control system is configured to control (e.g., by way of signals pH_{PS} and C_{FL}) the relative amounts of base product slipstream portion 113-21 and aqueous salt feedstock solution 111-IN1 in reaction chamber 193 such that a pH level of process solution 195 is maintained (on average) at a selected target divalent precipitation pH level (e.g., 11, 12.3, 13) that causes some or all of the divalent ions provided in feedstock solution 111-IN1 to precipitate from process solution 195 in the form of insoluble solids 195-S.

The generalized system described above may be utilized to perform various base and/or acid generating operations that involve the use of either 2-chamber or 3-chamber IE stacks. In one embodiment, system 100 is utilized to remove divalent ions (e.g., Ca²⁺ and Mg²⁺) from aqueous salt feedstock solution 111-IN2 before salt molecules (e.g., NaCl) provided in aqueous salt feedstock solution 111-IN2 is processed by BPED (electrochemical reactor) 110 to generate both acid product (e.g., HCl) disposed in acid product stream 112-2 and base product (e.g., NaOH) disposed in base product stream 113-2. This method involves utilizing a portion of the base product (e.g., NaOH) generated by BPED 110 (e.g., provided in slipstream portion 113-21 or by some other path) to increase a pH level of aqueous salt feedstock solution 111-IN2 above a precipitation level of one or more of the divalent ions (i.e., above the pH level at which one or more of the divalent ions precipitate), thereby causing these divalent ions to precipitate in the form of insoluble solids 195-S disposed in a supernatant solution (e.g., the portion of process solution 195 from which divalent ions have been precipitated/removed). The supernatant solution is then supplied (i.e., as aqueous base/salt solution 113-1) to BPED 110, whereby salt provided in the supernatant solution is processed to generate additional acid and base product. In another embodiment, BPED (electrochemical reactor) 110 is utilized to electrochemically process salt from a feedstock into acid product stream 112-2 and base product stream 113-2, and then a process solution 195 is generated (e.g., using chemical precipitator 190 or another device) by mixing a slipstream portion 113-21 of base product stream 113-2 and a corresponding portion of aqueous salt feedstock solution 111-IN2. As set forth above, generating the process solution 195 involves controlling the proportions of base product slipstream portion 113-21 and aqueous salt feedstock solution 111-IN2 such that a pH level of process solution 195 is maintained at a target divalent precipitation level (e.g., 11, 12.3, 13) that causes some or all of the divalent ions provided in the feedstock solution 111-IN2 to precipitate from the process solution 195 in the form of insoluble solids 195-S (e.g., CaCO₃, Ca(OH)₂, MgCO₃ and/or Mg(OH)₂). Next, aqueous salt solution 113-1 is generated by separating or otherwise removing insoluble solids 195-S (i.e., the precipitated divalent ions) from process solution 195, and directing the aqueous salt solution 113-1 to BPED 110, i.e., such that salt contained in aqueous salt solution 113-1 is converted into acid product and base product by BPED 110 in the manner described above.

The generalized system described above may also be utilized to convert NaCl (salt) into both NaOH and HCl (base and acid products) using 2-chamber IE stack 135. This method includes directing aqueous acid solution 112-1 through one or more acid (first) chambers 132 and directing aqueous salt/base solution 113-1 through one or more salt/base (second) chamber 133 that are separated from each other by intervening ion exchange membranes 134, and applying an electric field E across the chambers 132/133 such that at least some of the chloride ions Cl⁻ disposed in aqueous salt/base solution 113-1 pass through intervening ion exchange membranes 134 and combine with protons (H⁺) to form HCl in acid chamber 133, and such that at least some of the sodium ions Na⁺ disposed in aqueous salt/base solution 113-1 remain in the salt/base chamber 133 and combine with hydroxide ions OH⁻ to form NaOH in base product stream 112-2.

FIGS. 2A and 2B show alternative chemical precipitator configurations that may be utilized to implement the operations of chemical precipitator 190 in system 100 (FIG. 1).

Chemical precipitator 190A (FIG. 2A) includes a reactor 191A configured and controlled by an associated control system to remove divalent ions from aqueous salt feedstock solution 111A-IN according to an exemplary embodiment. Note that base product slipstream 113A-21 is received from an electrochemical reactor (e.g., BPED 110, FIG. 1), and that aqueous salt feedstock solution 111A-IN (e.g., seawater or brine) is received from a suitable source (e.g., ocean 50, shown in FIG. 1).

Reactor 191A generally includes a reactor housing 192A configured to contain a process fluid 195A, an outlet device 197A through which a portion of process fluid 195A is delivered to the electrochemical reactor (e.g., BPED 110, FIG. 1), and a solids removal mechanism 198A. Each of these reactor portions is described in additional detail in the following paragraphs.

Reactor housing 192A surrounds reaction chamber 193A and includes a side wall 192A-S extending between an upper end 191A-U of reactor 191A and a lower end 191A-B of reactor 191A. Reactor housing 192A also includes inlet ports 194A-1 and 194A-2 through which feedstock solution 111A-IN and base product slipstream portion 113A-21 enter reaction chamber 193A in the manner set forth below, whereby these fluids intermix in reaction chamber 193A to form process fluid 195A. In the exemplary embodiment, reactor housing 192A includes a conical side wall portion 192A-SC that tapers to a relatively narrow lower outlet opening 191A-OUT adjacent to lower end 191A-B. This tapered conical arrangement facilitates the removal of relatively high-density insoluble solids 195A-S that sink to the bottom of process fluid 195A, whereby solids 195A-S are guided by conical side wall portion 192A-SC through outlet opening 191A-OUT and into solids removal mechanism 198A (described below). Reactor housing 192A also includes one or more additional outlet ports including a first outlet port 192A-OUT1 through which a portion of outlet device 197A extends for reasons set forth below, and an optional second outlet port 192A-OUT2 that may be utilized to facilitate the removal of floating solids 195A-SF.

Solids removal mechanism 198A is mounted to a lower end of reactor housing 193A and configured to remove the insoluble solids 195A-S from associated reaction chamber 193A (e.g., solids that sink to the bottom of process solution 195A). In the exemplary embodiment, solids removal mechanism 198A includes a feed screw 198AS rotatably disposed in a feed pipe 198AP and a motor 198AM configured to rotate feed screw 198AS within feed pipe 198AP. As indicated by the dot-line arrows near the bottom of reaction chamber 193A, feed pipe 198AP is operably configured to receive insoluble solids 195A-S that are guided by conical side wall portion 192A-SC through a relatively narrow reactor outlet opening 191A-OUT and into a feed pipe inlet 198A-IN, and feed screw 198AS is driven by a motor such that insoluble solids 195A-S disposed in feed pipe 198AP are impelled by rotation of feed screw 198AS toward an outlet opening 198A-OUT of feed pipe 198AS. In this way, solids removal mechanism 198A expels insoluble solids 195A-S through outlet (end opening) 198A-OUT of feed pipe 198AS to a downstream destination (e.g., to optional alkaline solids processor 199, shown in FIG. 1).

Outlet device 197A is operably connected to reactor housing 192A and configured to facilitate the outflow of a portion of process fluid 195A (i.e., partially or fully processed aqueous salt/base solution 113A-1) from associated reaction chamber 193A. In this embodiment, outlet device 197A comprises a T-shaped pipe mounted to side wall 191A-S of reactor housing 191A such that an inlet 197A-IN of the T-shaped pipe is disposed inside reactor chamber 193A and outlet port 197A-OUT of the T-shaped pipe is disposed outside reactor housing 191A. Inlet 197A-IN is positioned within a region of the process chamber 193A containing a portion of the process solution 195A from which at least some of the divalent ions have been chemically removed (e.g., inlet 197A-IN is submerged within process solution 195A and located near an upper surface of process solution 195A). With this arrangement, partially or fully processed aqueous salt solution 113A-1 flows from reactor chamber 193A into inlet 195A-IN and outlet through the T-shaped pipe to outlet port 197A-OUT, whereby aqueous salt solution 113A-1 is directed to a downstream location (e.g., BPED 110) by way of pipe 151A-31. This arrangement also facilitates the efficient separation of supernatant when relatively dense insoluble solids 195A-S sink to the bottom of process solution 195A and less dense insoluble solids 195A-SF float to the top surface of process solution 195A and may be removed, e.g., by way of an outlet pipe 151A-32.

Similar to the arrangement described above with reference to FIG. 1, the control system utilized to control chemical precipitator 190A includes at least one sensor S, flow control devices 196A-1 and 196A-2 and a controller 180A. Sensor S is disposed in reaction chamber 193A and is configured to generate a process solution pH measurement signal pH_{PS} indicating a current (real time) pH value of process solution 195A. Flow control devices (e.g., dosing pumps) 196A-1 and 196A-2 are respectively configured to control inflow rates of aqueous salt feedstock solution 111A-IN and base product slipstream (first base product stream portion) 113A-21 into reaction chamber 193A by way of inlet ports 194A-1 and 194A-2, respectively. Specifically, flow control device 196A-1 controls a flow rate of aqueous salt feedstock solution 111A-IN into reaction chamber 193A in response to flow rate control signal C_{FL1}, and flow control device 196A-2 controls a flow rate of base product slipstream portion 113A-21 into the reaction chamber 193A in response to flow rate control signal C_{FL2}. Controller 180A is configured to monitor process solution pH measurement signal pH_{PS} and to adjust control signals C_{FL1} and C_{FL2} such that the proportional amounts of aqueous salt feedstock solution 111-IN and base product slipstream portion 113A-21 disposed reaction chamber 193A at a given time maintains a pH level of process solution 195A at a target pH level (e.g., a pH level in the range of 11 to 13.5). For example, the control system may be configured such that the process solution portion 195A contained reactor 191A is maintained at a target divalent precipitation pH level of 13 that causes some or all of the divalent ions (e.g., Ca²⁺ and Mg²⁺) provided in feedstock solution 111A-IN to precipitate from process solution 195A in the form of insoluble solids 195A-S (e.g., CaCO₃, Ca(OH)₂, MgCO₃ and/or Mg(OH)₂).

Referring to FIG. 2B, chemical precipitator 190B includes multiple series-connected reactors 191A-1, 191A-2 and 191A-3 that are configured and controlled by an associated control system to remove divalent ions from aqueous salt feedstock solution 111A-IN according to another embodiment. Referring to the right side of FIG. 2B, note that base product slipstream (first base product stream portion) 113A-21, which is received from a BPED (e.g., BPED 110, FIG. 1) is divided into three slipstream portions 113A-211, 113A-212 and 113A-213 that are respectively delivered to reactors 191A-1, 191A-2 and 191A-3. Although described with reference to three reactors and three slipstream portions, those skilled in the art will recognize that the details provided below with reference to chemical precipitator 190B may be utilized to generate a chemical precipitator having any number of series-connected reactors by way of dividing the base product slipstream into a corresponding number of slipstream portions.

As indicated in FIG. 2, each reactor 191A-1, 191A-2 and 191A-3 includes a reactor housing and is configured to contain and process an associated portion of the process solution in accordance with the control system in a manner similar to that described above with reference to FIG. 1. Specifically, reactor 191A-1 includes reactor housing 192A-1 surrounding reaction chamber 193A-1 that contains a first process solution portion 195A-1 formed by a mixture of aqueous salt feedstock solution 111A-IN and first base product slipstream portion 113A-211, reactor 191A-2 includes reactor housing 192A-2 surrounding reaction chamber 193A-2 surrounding reaction chamber 193A-3 that contains a second process solution portion 195A-2 formed by a mixture of a first overflow portion (partially processed solution) 195A-1OF received from first reactor 191A-1 (i.e., a portion of first process solution portion 195A-1 that exits first reaction chamber 193A-1 by way of outlet device 197A-1) and second base product slipstream portion 113A-212, and reactor 191A-3 includes reactor housing 192A-3 that contains a third process solution portion 195A-3 formed by a mixture of a second overflow portion 195A-20F received from second reactor 191A-2 (i.e., a portion of second process solution portion 195A-2 that exits second reaction chamber 193A-2 by way of outlet device 197A-2) and third base product slipstream portion 113A-213.

The control system of chemical precipitator 190B includes controller 180A1, sensors S1, S2 and S3, and flow control devices (e.g., dosing pumps) 196A-11, 196A-12 and 196A-12 that are collectively configured to maintain the process portion contained in each reactor 191A-1, 191A-2 and 191A-3 at a selected (different) target divalent precipitation pH level (i.e., such that each reactor 191A-1, 191A-2 and 191A-3 produces a corresponding selected (different) target insoluble solid). Sensors S1, S2 and S3 are respectively disposed in reactor housings 192A-1, 192A-2 and 192A-3, and configured to measure pH levels of process solution portions 195A-1, 195A-2 and 195A-3, respectively, in a manner similar to that described above with reference to FIG. 2A. Flow control devices 196A-11, 196A-12 and 196A-13 are controlled by controller 180A1 (e.g., by way of one or more control signals C_{FL11}, C_{FL12} and C_{FL13}, respectively) to control the flow of associated fluids into corresponding reaction chambers, where flow control device 196A-11 controls flow rates of a first portion 113A-211 of base product slipstream 113A-21 and feedstock solution 111A-IN into reaction chamber 193A-1 in response to control signal(s) C_{FL11}, flow control device 196A-12 controls a flow rate of a second base product slipstream 113A-212 into reaction chamber 193A-2 in response to control signal(s) C_{FL12}, and flow control device 196A-13 controls a flow rate of a third base product slipstream 113A-213 into reaction chamber 193A-3 in response to control signal(s) C_{FL13}. In this embodiment, the outflow rate of overflow portion 195A-1OF from reactor 191A-1 to reactor 191A-2 is substantially equal to the combined inflow rates of feedstock solution 111A-IN and first slipstream portion 113A-211, the outflow rate of overflow portion 195A-20F from reactor 191A-2 to reactor 191A-3 is substantially equal to the combined inflow rates of overflow portion 195A-10F and second slipstream portion 113A-212, and the outflow rate of aqueous salt/base solution 113A-1 from reactor 191A-3 by way of outlet device 197A-3 to a downstream destination (e.g., BPED 110, shown in FIG. 1) is substantially equal to the combined inflow rates of overflow portion 195A-20F and third slipstream portion 113A-213. In other embodiments the inflow/outflow rates of overflow portions 195A-10F and 195A-20F and/or aqueous salt/base solution 113A-1 may be controlled by way of additional flow control devices (not shown).

Controller 180A1 is configured using known techniques to utilize pH measurement data received from sensors S1, S2 and S3 to control dosing pumps 196A-11, 196A-12 and 196A-13 such that the various process solution portions contained in each reaction chamber is maintained at a different target divalent precipitation pH level such that each reactor produces a corresponding (different) selected insoluble solid. For example, controller 180A1 utilizes pH measurement data pH_{PS1} received from sensor S1 to adjust the inflow rates (amounts) of aqueous salt feedstock solution 111A-IN and first base product stream portion 113A-211 into reaction chamber 193A-1 such that process solution 195A-1 is maintained at a relatively low (first) target divalent precipitation pH level (e.g., pH 11), thereby precipitating Mg²⁺ ions to form (first) insoluble alkaline solids 195A-S1 comprising magnesium hydroxide (Mg(OH)₂) in process solution 195A-1, whereby alkaline solids 195A-S1 sink to the bottom of reaction housing 192A-1 and are then removed from reaction chamber 193A-1 by way of solids removal mechanism 198A-1 in the manner described above with reference to FIG. 2A. Because the relatively low pH level generated in reactor 191A-1 is too low to precipitate all divalent ions supplied in feedstock solution 111A-IN, residual process solution (supernatant) 195A-1 remaining in reaction chamber 193A-1 is partially processed in that some divalent ions (e.g., Mg²⁺ ions) have been removed but residual process solution 195A-1 still contains other divalent ions (e.g., Ca²⁺ ions). This partially processed salt/base solution is then passed as overflow portion 195A-10F by way of outlet device 197A-1 to reactor 191A-2 where it is mixed with second slipstream portion 113A-212 to generate second process solution portion 195A-2. Controller 180A1 utilizes pH measurement data pH_{PS2} received from sensor S2 to coordinate the inflow rates (amounts) of overflow portion 195A-10F and slipstream portion 113A-212 into reaction chamber 193A-2 such that process solution 195A-2 is maintained at an intermediate (second) target divalent precipitation pH level (e.g., pH 12.3), thereby precipitating at least some of the remaining divalent ions (e.g., Ca²⁺ ions) to form (second) insoluble alkaline solids 195A-S2 comprising calcium carbonate (CaCO₃) in process solution 195A-2, which sink and are then removed from reaction chamber 193A-2 by way of solids removal mechanism 198A-2. Finally, controller 180A1 utilizes pH measurement data pH_{Ps3} received from sensor S3 to coordinate the inflow rates (amounts) of overflow portion 195A-20F of twice-processed supernatant (process solution) 195A-2) and slipstream portion 113A-213 into reaction chamber 193A-3 such that process solution 195A-3 is maintained at a relatively high (third) target divalent precipitation level (e.g., approximately pH 13), thereby precipitating remaining divalent ions to produce (third) selected insoluble alkaline solids 195A-S3 comprising, for example, calcium hydroxide (Ca(OH)₂), which are then removed from reaction chamber 193A-3 by way of solids removal mechanism 198A-3.

In the embodiment depicted in FIG. 2A, process solution 195A-3 disposed in reactor 191A-3 serves as the fully processed aqueous salt/base solution 113A-1 that is transmitted to a chemical reactor (e.g., BPED 110, see FIG. 1). In other embodiments, a fourth reactor (not shown) may be added downstream of reactor 191A-3 to further process the solution at an even higher pH level (e.g., at pH 14) to achieve a higher level of divalent ion removal before the solution is passed to the chemical reactor. In other embodiments, any number of series-connected reactors (e.g., two or more than four) may be utilized. It is currently believed that any additional divalent ion removal advantages that might be achieved by processing solution at pH levels greater than 14 are offset by the corrosive damage that solution at such a high pH level might inflict on the system. In some embodiments, one or more of the separately produced target insoluble solids (e.g., Mg(OH)₂ and/or Ca(OH)₂) are immediately available for OAE purposes (e.g., mixed with seawater or utilized for direct air capture), or are sold for use in other processes, thus further reducing the LCOC of an OAE system implementing chemical precipitator 190A1. For example, Mg(OH)₂ will readily dissolve if added back to seawater, meaning that the alkalinity incorporated into Mg(OH)₂ will not be “lost” from an OAE CO₂ removal perspective. Instead, these hydroxide ions will have served a dual purpose of precipitation of Mg(OH)₂ for pretreatment and the removal of CO₂ via OAE. Moreover, the alkalinity per unit mass and volume of Mg(OH)₂ is much higher than for 0.5M aqueous NaOH, allowing for its dispersal further off shore.

FIG. 3 shows a partial OAE system 100B including a BPED 110B, a fluid buffering system 120B and a chemical precipitator 190B according to another exemplary embodiment. As set forth in the following paragraphs, FIG. 3 provides additional BPED and flow control details that are utilized by at least some systems configured in accordance with the present invention. Chemical precipitator 190B is indicated in a generalized form to illustrate its association with BPED 110B and may be implemented using any feature(s) of the embodiments described herein. OAE system 100B also includes additional components (e.g., an optional pretreatment unit and a control system) that are configured and operate according to one or more of the embodiments described herein but are omitted from FIG. 3 for clarity and brevity. Similarly, some or all of the details described with reference to FIG. 3 may be implemented in any of the embodiments described herein.

Referring to the upper portion of FIG. 3, fluid buffering system 120B includes an acid buffer tank 121B-2 and an optional salt/base buffer tank 121B-3. Acid buffer tank 121B-2 receives salt feedstock solution 111B-IN and a feedback portion 112B-21 of acid product stream 112B-2 from ED apparatus 130B such that these two fluids combine to form aqueous acid solution 112B-1 in tank 121B-2, which is then directed to acid chambers of ED apparatus 130B as set forth below. Optional salt/base buffer tank 121B-3 receives processed salt/base solution 113B-11 from chemical precipitator 190B (e.g., by way of pipe 151B-31) and a feedback portion 113B-21 of base product stream 113B-2 from ED apparatus 130B such that these two fluids combine to form aqueous salt/base solution 113B-12 in tank 121B-3, which is then directed to salt/base chambers of ED apparatus 130B as set forth below. In an embodiment, each buffer tank 121B-2 and 121B-3 can be implemented using a standard 1000L IBC caged tote tank.

The flow of acid solution and salt/base solution through ED apparatus 130B is implemented by way of various pipes and controlled by flow control system 140B. Aqueous acid solution 112B-1 is transmitted from tank 121B-2 to ED apparatus 130B by way of pipe 151B-2 and pump 145B-21, and acid product stream 112B-2 is transmitted from ED apparatus 130B by way of pipe 151B-2, where a valve 146B-2 directs first portion 112B-21 to tank 121B-2 by way of pump 145B-22 and pipe 153B-21 and second portion 112B-22 to a downstream acid processing unit or other downstream acid destination DAD (not shown) by way of pump 145B-23 and pipe 153B-22. Aqueous salt/base solution 113B-12 is transmitted from tank 121B-3 to ED apparatus 130B by way of pipe 151B-32 and pump 145B-31, and base product stream 113B-2 is transmitted from ED apparatus 130B by way of pipe 152B-3, where a valve 146B-3 directs first portion 113B-21 to tank 121B-2 by way of pump 145B-32 and pipe 153B-31 and second portion 113B-22 to alkalinity product generation unit 147B by way of pump 145B-33 and pipe 153B-32. Alkalinity product generation unit 147B functions to process second base generation stream portion 113B-22 to generate alkalinity product 113B-OUT, which is transmitted to ocean 50 by way of transfer-out pipe 52B.

Referring to the central portion of FIG. 3, ED apparatus 130B comprises an ion exchange stack 135B including acid chambers 132B1 and 132B2 and salt/base chambers 133B1 and 133B2, an anion exchange membrane 134B-1 and two bipolar ion exchange membranes (bipolar membranes) 134B-21 and 134B-22. Portions of aqueous acid solution 112B-1 are respectively directed into acid chambers 132B1 and 132B2 by way of respective pipe sections (or by way of an input manifold, as described below with reference to FIG. 4), and portions of acid product stream 112B-2 leaving acid chambers 132B1 and 132B2 are directed by way of respective pipe sections (or by way of an output manifold, as described below with reference to FIG. 4) to pipe 152B-2. Similarly, portions of aqueous salt/base solution 113B-1 are respectively directed into salt/base chambers 132B1 and 132B2 and portions of salt/base product stream 113B-2 leaving salt/base chambers 132B1 and 132B2 are directed to pipe 152B-3. The acid and salt/base chambers are aligned in an alternating arrangement between an anode 138B+ and a cathode 138B− (i.e., from left to right, stack 135B includes acid chamber 132B1, salt/base chamber 133B1, acid chamber 132B2 and salt/base chamber 133B2). Adjacent pairs of acid and salt/base chambers are separated either by an anion exchange membrane or a bipolar membrane, which are also aligned in an alternating arrangement. That is, acid chamber 132B1 and salt/base chamber 133B1 are separated by bipolar membrane 134B21, salt/base chamber 133B1 and acid chamber 132B2 are separated by anion exchange membrane 134B1, and acid chamber 132B2 and salt/base chamber 133B2 are separated by bipolar membrane 134B22, whereby anion exchange membrane 134B-1 is disposed between bipolar membranes 134B1 and 134B2.

During operation, ED apparatus 130B performs the electrochemical process mentioned above with reference to FIG. 1 by way of generating a suitable electric field across stack 135B while directing acid solution through acid chambers 132B1 and 132B2 and directing salt/base solutions through salt/base chambers 133B1 and 133B2. As depicted by the dashed-line arrow in FIG. 3, a suitable voltage source V_{STACK} applies a negative potential to anode 138B+ and a positive potential to cathode 138B−, whereby the resulting potential is strong enough to generate an electric field E that passes through all of chambers 132B1, 133B1, 132B2 and 133B1 and the intervening membranes between anode 138B+ and cathode 138B−.

Although depicted in FIG. 3 as including only four chambers for clarity and brevity, ion exchange stack 135B may include any number of alternating acid and salt/base chambers and associated alternating anion exchange and bipolar membranes (e.g., as depicted and described below with reference to FIG. 4). In addition, the electrochemical process performed by ED apparatus 130B is similar to that described in additional detail below with reference to FIG. 4.

FIG. 4 shows a partial OAE system 100C including an electrodialysis apparatus 130C according to another exemplary embodiment. As set forth in the following paragraphs, FIG. 4 provides additional details associated with electrodialysis apparatuses utilized by at least some systems configured in accordance with the present invention. OAE system 100C also includes additional BPED components, an optional pretreatment unit, a chemical precipitator and a control system that are configured and operate according to one or more of the embodiments described herein but are omitted from FIG. 4 for clarity and brevity. Similarly, some or all of the details described with reference to FIG. 4 may be implemented in the electrodialysis apparatus of any of the embodiments described herein.

Similar to previous embodiments, electrodialysis apparatus 130C including an ion exchange stack 135C made up of series-connected 2-chamber cells C1, C2 . . . CN arranged in series between anode 138C+ and cathode 138C−, where each cell includes an associated acid chamber and an associated salt/base chamber separated by an ion exchange membrane and sandwiched between two bipolar membranes. For example, cell C1 includes acid chamber 132C2 and salt/base chamber 133C1 separated by ion exchange membrane 134C11 and sandwiched between (first) bipolar membrane 134C21 and (second) bipolar membrane 134C22. Similarly, cell C2 includes acid chamber 132C3 and salt/base chamber 133C2 separated by ion exchange membrane 134C12 and sandwiched between (first) bipolar membrane 134C22 and a (second) bipolar membrane (not shown), and cell CN includes acid chamber 132CN and salt/base chamber 133CN separated by ion exchange membrane 134C1N and sandwiched between a (first) bipolar membrane (not shown) and (second) bipolar membrane 134C2N. Note that each adjacent pair of cells shares an intervening bipolar membrane (e.g., bipolar membrane 134C22 serves as the second bipolar membrane for cell C1 and the first bipolar membrane for cell C2). In addition, ion exchange stack 135C may include one or more additional “end” acid and/or salt/base chambers that may be needed to facilitate the redox operations described below (e.g., end acid chamber 132C1 is disposed between cell C1 and anode 138C+, and end salt/base chamber 133CM is disposed between cell CN and cathode 138C−).

Electrodialysis apparatus 130C also includes an input manifold 136C-1 and an output manifold 136C-2 that coordinate the flow of aqueous acid solution and aqueous salt/base solution through appropriate chambers of ion exchange stack 135C. Referring to the upper portion of FIG. 4, input manifold 136C-1 is configured to receive aqueous acid stream 112C-1 from an acid buffer tank (e.g., tank 121-2 shown in FIG. 1) by way of an associated pipe 151C-2 and aqueous base stream 113C-1 from a chemical precipitator (e.g., chemical precipitator 190 shown in FIG. 1) by way of an associated pipe 151C-3, to direct a portion of aqueous acid stream 112C-1 into the acid chamber of each cell C1, C2 . . . CN of ion exchange stack 135C, and to direct a portion of aqueous salt/base solution 113C-1 into the salt/base chamber of each cell C1, C2 . . . CN. For example, input manifold 136C-1 directs a first portion of acid stream 112C-1 into acid chamber 132C2 of cell C1 and a second portion of acid stream 112C-1 into acid chamber 132C3 of cell C2). Input manifold 136C-1 also directs portion of acid stream 112C-1 into any other acid chambers (e.g., chamber 132C1) of ion exchange stack 135C. Referring to the lower portion of FIG. 4, output manifold 136C-2 is configured to receive and combine portions of acid product 112C-2 exiting each of the acid chambers of ion exchange stack 135C, and to receive and combine portions of acid product 112C-2 exiting each of the acid chambers of ion exchange stack 135C, and to receive and combine portions of the base product 113C-2 exiting each of the salt/base chambers ion exchange stack 135C. That is, output manifold 136C-2 combines the acid product portions into a single acid product stream 112C-2 that is transmitted to downstream acid locations (DAL) by way of a pipe 152C-2 and separately combines the salt/base product portions into a single base product stream 113C-2 that is transmitted to downstream base locations (DBL) by way of a pipe 152C-3. Referring briefly to FIG. 3, downstream locations DAL include acid buffer tank 121B-2, and downstream locations DBL include chemical precipitator 190B. Input manifold 136C-1 and output manifold 136C-2 configured to provide the features described above may be constructed using known materials and techniques.

To facilitate the desired flow of ions through ion exchange stack 135C, exchange stack 135C further includes a pair of oxidation-reduction (redox) chambers disposed between anode 138C+ and cathode 138C- and cells C1, C2 . . . CN, and includes an electrolyte solution circulation system 139C configured to operably circulate an electrolyte solution 114C through the redox chambers. A first redox chamber 137C-1 is disposed between anode 138C+ and cell C1 and is separated from end acid chamber 132C1 by an intervening (e.g., anion/cation exchange or bipolar) membrane F1. A second redox chamber 137C-2 is disposed between cathode 138C- and cell CN and is separated from salt/base chamber 133CN by intervening (e.g., anion/cation exchange or bipolar) membrane F2. Electrolyte solution circulation system 139C includes a reservoir 139C-0, flow lines 139C-1, 139C-2 and 139C-3 and a pump 139C-4 that are configured to circulate an electrolyte solution 114C (e.g., sodium sulfate or a semi conductive solution such as sodium hydroxide) through redox chambers 137C-1 and 137C-2. In an exemplary embodiment, as indicated by the bubble sections appearing at the bottom of FIG. 4, electrolyte solution circulation system 139C functions to supply sodium ions at one end of ion exchange stack 135C (i.e., from redox chamber 137C-2 into end salt/base chamber 133CM by way of membrane F2), and to remove sodium ions at the other end of ion exchange stack 135C (i.e., from end acid chamber 133C1 into redox chamber 137C-1 by way of membrane F1).

FIGS. 5A and 6A respectively depict simplified OAE systems 100E and 100D according to two additional embodiments. Similar to the systems described above, each of OAE system 100E (FIG. 5A) and OAE system 100D (FIG. 6A) includes an associated BPED 110E and 110D, a feedstock pretreatment unit 160E and 160D, and an associated chemical precipitator 190E and 190D. BPED 110E (FIG. 5A) and BPED 110D (FIG. 6A) respectively include an associated fluid buffering system (FBS) 120E and 120D, an associated ED apparatus 130E and 130D, an associated flow control system 140E and 140D. Each fluid buffering system 120E and 120D includes an associated acid buffer tank 121E-2 and 121D-2 respectively configured to contain an aqueous acid solution in the manner described above. Each ED apparatus 130E and 130D includes an associated ion exchange stack 135E and 135D mounted between an associated input manifold 136E-1 and 136D-1 and an associated output manifold 136E-2 and 136D-2. Each ion exchange stack 135E and 135D respectively includes multiple cells that are arranged in series between an associated anode 138E+ and 138D+ and an associated cathode 138E− and 138D−, which are utilized to generate electric fields E across ion exchange stacks 135E and 135D in the manner described above, for example, with reference to FIG. 4. As indicated in FIGS. 5B and 6B, which show portions of ion exchange stacks 135E and 135D that include exemplary cells C1E and C1D, respectively, each of the multiple series-connected cells of ED apparatuses 130E and 130D is configured in the manner described above with reference to exemplary cell C1 shown in FIG. 4. That is, cell C1E (FIG. 5B) includes an ion exchange membrane 134E-1 configured to transmit ions between an acid chamber 132E1 and an associated salt/base chamber 133E2, and cell C1D (FIG. 6B) includes an ion exchange membrane 134D-1 configured to transmit ions between an acid chamber 132D1 and an associated salt/base chamber 133D2. Referring again to FIGS. 5A and 6A, flow control systems 140E and 140D are configured to direct (e.g., by way of pipes 155E-21 and 155D-21) at least a portion of the aqueous acid solution 112E-1 and 112D-1 from acid buffer tanks 121E-2 and 121D-2 to acid chambers of each cell of an associated one of ED apparatuses 130E and 130D, and to separately direct the aqueous base solution 113E-1 and 113D-1 from an associated chemical precipitator 190E and 190D to the salt/base chamber of each cell of ED apparatuses 130E and 130D. Chemical precipitators 190E and 190D are configured and operate according to one of the embodiments described above and are therefore depicted in a simplified manner in FIGS. 5A and 6A, and further description is omitted for brevity.

OAE systems 100E (FIG. 5A) and 100D (FIG. 6A) are similar in that pretreatment units 160E and 160D are respectively used to supply pretreated feedstock solution(s) to associated chemical precipitators 190E and 190D by removing solid contaminants from raw salt feedstock solution (e.g., either seawater or brine) 111-IN1. Referring to FIG. 5A, feedstock pretreatment unit 160E generates and supplies pretreated feedstock solution 111E-IN2 to associated chemical precipitator 190E and also to acid buffer tank 121E-2 of BPED unit 110E. As shown in FIG. 6A, feedstock pretreatment unit 160D generates and supplies pretreated feedstock solution 111D-IN2 to an associated chemical precipitator 190D. Each pretreatment unit 160E (FIG. 5A) and 160D (FIG. 6A) includes at least one filtering system that is configured to remove at least one of solid particles, metals and biological materials from raw salt feedstock solution 111-IN1, which is received, for example from ocean 50 by way of transfer pipe 53. Referring to FIG. 5A, pretreatment unit 160E includes a first filtering system 161E configured to remove solid particles from seawater/brine 111-IN1 (e.g., using a first filter 162E), and a second filtering system 163E configured to remove one or more of metals and biologic materials (e.g., using one or more second filters 164E) from the partially filtered seawater/brine 111-IN11 received from first filtering system 161E. Similarly, pretreatment unit 160D (FIG. 6A) includes a first filtering system 161D that utilizes first filter(s) 164D to remove solid particles from seawater/brine 111-IN1, and a second filtering system 163D that utilizes second filter(s) 164E to remove metals and/or biologic materials from the partially filtered seawater/brine 111-IN11 received from first filtering system 161D. As indicated by the horizontal solid-line arrows in FIGS. 5A and 6A, contaminants (e.g., removed solids, metals and/or biological materials) are prevented from passing downstream by associated filters and are removed from the flow path using known techniques, and, as indicated by the horizontal dash-line arrows, the resulting filtered feedstock solution (i.e., the solution passed through filters 164E and 164D) is passed downstream for use as described below.

OAE systems 100E (FIG. 5A) and 100D (FIG. 6A) differ in that, in the case of system 100E, the same pretreated aqueous salt feedstock solution 111E-IN2 generated by pretreatment unit 160E is supplied to both acid buffer tank 121E-2 and chemical precipitator 190E, whereas in the case of system 100D (FIG. 6A), pretreatment unit 160D utilizes an additional filtering unit (e.g., reverse osmosis (RO) system 165D) to generate both an aqueous salt feedstock solution 111D-IN2 and a desalinated solution (second feedstock solution portion) 115D (i.e., such that the aqueous salt feedstock solution 111D-IN2 has a higher salt concentration that the desalinated solution 115D).

Referring to FIG. 5A, flow control system 140E directs (e.g., by way of pipe 155E-11) a first portion 111E-IN21 of aqueous salt feedstock solution 111E-IN2 from pretreatment unit 160E to acid buffer tank 121E-2 and directs (e.g., by way of pipe 155E-12) a second portion 111E-IN22 of aqueous salt feedstock solution 111E-IN2 from pretreatment unit 160E to chemical precipitator 190E. Acid buffer tank 121E-2 serves to mix first feedstock solution portion 111E-IN21 with feedback acid solution portion 112E-21, which is directed to acid buffer tank 121E-2 by way of pipe 155E-41, and to supply the resulting (relatively weak) acid solution 112E-1 to ED apparatus 130E by way of pipe 155E-22. As mentioned above, input manifold 136E-1 serves to direct portions of acid solution 112E-1 into the acid (first) chamber of each cell of ion exchange stack 135E, whereby acid solution 112E-1 is electrochemically processed as described below with reference to FIG. 5B. Output manifold 136E-2 serves to direct portions of (relatively strong) acid product stream 112E-2 exiting the acid chambers by way of an outflow pipe 155E-32. As indicated, a second portion 112E-22 of acid product stream 112E-2 may be siphoned out of system 100E as an aqueous acid byproduct 112E-OUT for commercial or other purposes. Chemical processor 190E serves to mix second feedstock solution portion 111E-IN22 with feedback salt/base solution portion 113E-21, which is directed to chemical processor 190E by way of pipe 155E-42, and to supply the resulting (relatively high salt content and relatively low base content) aqueous salt/base solution 113E-1 to ED apparatus 130E by way of pipe 155E-23. Input manifold 136E-1 serves to direct portions of salt/base solution 113E-1 into the salt/base (second) chamber of each cell of ion exchange stack 135E, whereby salt/base solution 113E-1 is electrochemically processed as described below with reference to FIG. 5B. Output manifold 136E-2 serves to direct portions of processed (relatively low salt content and relatively high base content) base product stream 113E-2 exiting the salt/base chambers by way of an outflow pipe 155E-33. A second portion 113E-22 of base product stream 113E-2 is directed to an alkalinity product generation unit (APGU) for purposes of generating an ocean alkalinity product in the manner described above.

FIG. 5B shows a simplified portion of OAE system 100E (see FIG. 5A) that depicts an electrochemical process performed in representative cell C1E of ion exchange stack 135E. The two vertical dashed-line arrows respectively indicate the flow path of salt/base and acid solutions through ion exchange stack 135E, where the left-side arrow indicates the flow of salt/base solution from chemical precipitator 190E (shown in FIG. 5A) through salt/base chamber 133E1 of cell C1E, and the right-side arrow indicates the flow of acid solution from acid buffer tank 121E-2 (shown in FIG. 5A) through acid chamber 132E2 of cell C1E. Shown in FIG. 5B above ion exchange stack 135E are cutaway sections (representative portions) of pipes 155E-22 and 155E-23, which as indicated in FIG. 5A are utilized to respectively deliver aqueous acid solution 112E-1 (H₂O+NaCl+HCl) and aqueous salt/base solution 113E-1 (H₂O+NaCl+NaOH) to ion exchange stack 135E. Shown below ion exchange stack 135E in the lower portion of FIG. 5B are cutaway sections of pipes 155E-32 and 155E-33, which as indicated in FIG. 5A are utilized to respectively deliver acid product stream 112E-2 (H₂O+NaCl+HCl) and base product stream 113E-2 (H₂O+NaOH+NaCl) to the downstream locations indicated in FIG. 5A. Other details (e.g., flow control devices and input/output manifolds) are omitted from FIG. 5B for clarity and brevity.

FIG. 5B includes exemplary concentrations of salt (NaCl), acid (HCl) and base (NaOH) of the acid and salt/base solutions before and after passing through ion exchange stack 135E. Referring to the upper portion of FIG. 5B, exemplary pre-processing concentrations of salt (3.5%), acid (2%) and base (2%) of solutions 112E-1 and 113E-1 are indicated in FIG. 5A next to pipe sections 155E-22 and 155E-23. Note that salt (NaCl), acid (HCl) and base (NaOH) is contained in aqueous acid solution 112E-1 and salt/base solution 113E-1 as dissociated ions (e.g., salt is dissociated into Na⁺ and Cl⁻ ions, as indicated by the notation “Na⁺Cl⁻” in FIG. 5B). Referring to the lower portion of FIG. 5B, exemplary post-processing concentrations of salt, acid and base of product streams 112E-2 and 113E-2 are indicated next to pipe sections 155E-32 and 155E-33 in FIG. 5B. Differences in the pre- and post-processing concentration values indicate changes (i.e., relatively high to relatively low, or relatively low to relatively high) to the acid/base/salt compositions that occur during electrochemical processing. For example, the post-processing salt concentration in base product stream 113E-2 (e.g., 3.0%) is relatively low compared to the pre-processing salt concentration (e.g., 3.5%), which indicates the consumption (conversion) of salt from the salt/base stream during the electrochemical process performed in stack 135E. In contrast, the post-processing base concentration in base product stream 113E-2 (e.g., 2.5%) is higher than the pre-processing base concentration (e.g., 2.0%), which indicates the generation and addition of base molecules (NaOH) into the salt/base stream during the electrochemical process, and the post-processing acid concentration in acid product stream 112E-2 (e.g., 2.5%) is higher than the pre-processing acid concentration (e.g., 2.0%), which indicates the generation/addition of acid molecules (HCl) into the acid stream during the electrochemical process. Finally, note that the post-processing salt concentration in acid product stream 112E-2 (e.g., 3.5%) is equal to the pre-processing salt concentration (e.g., 3.5%) in acid solution stream 112E-1, which indicates that salt is neither removed nor added to the salt/base stream during the electrochemical process.

FIG. 5B shows a portion of ion exchange stack 135E that includes cell C1E and portions of adjacent cells. Cell C1E includes acid chamber 132E2 and salt/base chamber 133E1 separated by ion exchange membrane 134E1 (i.e., either an AEM or CEM membrane) and sandwiched between a first bipolar membrane 134E-21 and a second bipolar membrane 134E-22. Bipolar membrane 134E-21 separates salt/base chamber 133E1 of cell C1E from an acid chamber 132E1 of a first adjacent cell, and bipolar membrane 134E-22 separates acid chamber 132E2 of cell C1E from a salt/base chamber 133E2 of a second adjacent cell. As indicated by bipolar membrane 134E-21, each bipolar membrane 134E-21 and 134E-22 is a laminate including an anion-exchange layer (AEL) and a cation-exchange layer (CEL) that are bonded along an intervening junction (J). Note that bipolar membranes 134E-21 and 134E-22 mostly block the passage of Na⁺ and Cl⁻ ions between adjacent chambers (e.g., from acid chamber 133E1 into salt/base chamber 132E1, and vice-versa). Anion exchange membrane 134E-1 allows Cl⁻ and OH⁻ ions to pass from salt/base chamber 133E1 to acid chamber 132E2 but prevents passage of most H⁺ and Na⁺ ions from acid chamber 132E2 to salt/base chamber 133E1.

During electrochemical processing electrodes V+ and V− are actuated to apply a suitable electric field E across ion exchange stack 135E and flow control system 140E (FIG. 5A) causes acid solution 112E-1 and salt/base solution 113E-1 to flow into ion exchange stack 135E by way of input manifold 136E-1. Upon entering ion exchange stack 135E, electric field E biases positive ions (Na⁺, H⁺) in the two solutions toward the cathode (V−) and biases negative ions (Cl⁻, OH⁻) in the two solutions toward the anode (V+). This bias effectively causes some water molecules (H₂O) to move from either side of each bipolar membrane 134E-21 and 134E-22 (i.e., either through the CEL or the AEL) to its junction J, where the H₂O molecules are dissociated into H⁺ and OH⁻ ions. In some embodiments this dissociation is enhanced by a catalyst C disposed at the junction of each bipolar membrane. Electric field E combined with the ion selectivities of the AEL and CEL cause the dissociated OH⁻ and H⁺ ions to move in different directions away from junction J, for example from bipolar membrane 134E-21 into acid chamber 133E1 and salt/base chamber 132E1. Electric field E also causes dissociated Cl⁻ ions to pass through anion exchange membrane 134E-1 from salt/base chamber 133E1 into acid chamber 132E2, where they combine with hydrogen ions to form new HCl (acid) molecules in acid product stream 112E-2, whereby the electrochemical process increases the amount (concentration) of acid (i.e., the pH of the acid stream is decreased). In addition, within acid chamber 132E, the OH⁻ ions combine with Na⁺ ions to form NaOH (base) molecules in base product stream 113E-2, whereby the electrochemical process also increases the amount of base (i.e., the pH of the salt/base stream is increased). In this manner, electrochemical processing produces changes (i.e., relatively high to relatively low, or relatively low to relatively high) in the acid/base/salt compositions that are discussed above.

Referring to FIG. 6A, system 100D differs from system 100E (FIG. 5A) in that pretreatment unit 160D utilizes a reverse osmosis (RO) system 165D to generate a base/salt solution having a relatively high salt concentration and an acid solution having a relatively low salt concentration. RO system 165D utilizes a suitable filter(s) 166E to process filtered seawater/brine 111-IN12, which is received from filter system 163D, in a way that generates an aqueous salt feedstock solution 111D-IN2 and a desalinated solution (second feedstock solution portion) 115D. Flow control system 140D is configured to deliver desalinated solution 115D, which has a low or zero salt content, by way of pipe 155D-11 to acid buffer tank 121D-2 such that it mixes with feedback acid solution portion 112D-21, which is directed to acid buffer tank 121D-2 by way of pipe 155D-41, and to supply the resulting (relatively weak) acid solution 112D-1 to ED apparatus 130D by way of pipe 155D-22. Flow control system 140D is also configured to deliver aqueous salt feedstock solution 111D-IN2, into which salt is concentrated by filter 166E and therefore has a higher salt concentration than desalinated solution 115D, by way of pipe 155D-12 to chemical precipitator 190D such that it mixes with feedback base solution portion 113D-21, which is directed to chemical precipitator 190D by way of pipe 155D-42, and to supply the resulting (relatively weak) base solution 113D-1 to ED apparatus 130D by way of pipe 155D-23. ED apparatus 130D is configured and operated to electrochemically process acid solution 112D-1 and base solution 113D-1 in a manner similar to that described above with reference to system 100E (FIG. 5A), with differences described below with reference to FIG. 6B.

FIG. 6B shows a simplified portion of OAE system 100D (see FIG. 6A) that depicts an electrochemical process performed in representative cell C1D of ion exchange stack 135D. Similar to FIG. 5B (described above), the two vertical dashed-line arrows respectively indicate the flow path of salt/base and acid solutions through ion exchange stack 135D, where the left-side arrow indicates the flow of aqueous salt/base solution 113D-1 from chemical precipitator 190D to salt/base chamber 133D1 of cell C1D by way of pipe 155D-23 and the flow of base product stream 113D-2 from salt/base chamber 133D1 to downstream locations by way of pipe 155D-33, and the right-side arrow indicates the flow of aqueous acid solution 112D-1 from acid buffer tank 121D-2 to acid chamber 132D2 of cell C1D by way of pipe 155D-22 and the flow of acid product stream 112D-2 from acid chamber 132D2 to downstream locations by way of pipe 155D-32. As with FIG. 5B, various simplifications and other details are omitted from FIG. 6B for clarity and brevity.

FIG. 6B also indicates exemplary general compositions of the acid and salt/base solutions before and after passing through ion exchange stack 135D. Similar to the non-RO embodiment described above with reference to FIG. 5B, the acid (HCl) concentration of aqueous acid solution 112D-1 and the base (NaOH) concentration of aqueous salt/base solution 113D-1 are relatively low (e.g., 2%), and the acid concentration of acid product stream 112D-2 and the base concentration of base product stream 113D-2 are relatively high (e.g., 2.5%). Also similar to the non-RO embodiment described above with reference to FIG. 5B, aqueous salt/base solution 113D-1 has a relatively high salt concentration (e.g., 7%) and a base product solution 113D-2 has a relatively low salt concentration (e.g., 3.5%) due to the conversion of salt during the electrochemical process performed in ion exchange stack 135D. The main differences between the example shown in FIG. 6B from that shown in FIG. 5B are the higher initial salt concentration in aqueous salt/base solution 113D-1 and the absence of salt in the acid solution, where these changes are caused by the presence of RO system 165D in pretreatment unit 160D (shown in FIG. 6A). Otherwise, composition and operation of cell C1D are essentially the same as that described above with reference to cell C1E (FIG. 5B), and the electrochemical process performed in cell C1D (i.e., in the presence applied electric field E) is substantially the same as that described above with reference to cell C1E.

Although the invention is primarily described herein in the context of an OAE system and associated methods that utilizes a BPED including a 2-chamber IE stack arrangement to generate NaOH, various novel aspects described herein may be beneficially utilized in other systems/methods without departing from the spirit and scope of the invention. For example, a chemical precipitator may be utilized as described herein to remove divalent ions from a salt feedstock solution before NaCl in the salt feedstock solution is electrochemically processed by any type of electrochemical reactor, for example, to generate HCl and/or NaOH for commercial purposes. In addition, the methodology implemented by the present invention may be utilized to electrochemically process a wide variety of salt types to generate corresponding base and acid substances. Moreover, utilizing a chemical precipitator to remove divalent ions from a salt feedstock solution may be beneficially implemented in systems including chemical reactors that utilize 3-chamber IE stack arrangements to generate acid and base products. It will be clear to those skilled in the art that the inventive features of the present invention are applicable to these other embodiments as well, and that all of which are intended to fall within the scope of the present invention.

1. A system comprising:
an electrochemical reactor that is configured to generate an acid product stream including an acid substance and a base product stream including a base substance by electrochemically processing salt provided in an aqueous salt/base solution;
a chemical precipitator configured to generate a process solution by mixing a slipstream portion of the base product stream with a n aqueous salt feedstock solution containing salt molecules and divalent ions; and
a control system configured to control the relative amounts of the base product slipstream portion and the aqueous salt feedstock solution disposed in the chemical precipitator such that a pH of the process solution is at a divalent precipitation pH level that causes the divalent ions to precipitate in the form of insoluble solids,
wherein the chemical precipitator is further configured to generate the aqueous salt/base solution by removing the insoluble solids from the process solution before the aqueous salt/base solution is supplied to the electrochemical reactor.

2. The system of claim 1, wherein the chemical precipitator comprises a reactor including a reactor housing, an outlet device and a solids removal mechanism, wherein the reactor housing surrounds the reaction chamber, wherein the outlet device is operably connected to the reactor housing and configured to remove salt/base solution from its associated reaction chamber, and wherein the solids removal mechanism is mounted to the reactor housing and configured to remove the insoluble solids from its associated reaction chamber.

3. The system of claim 2,
wherein the reactor housing includes a side wall extending between an upper end of the reactor and a lower end of the reactor,
wherein the side wall includes a conical side wall portion that includes a relatively narrow outlet opening adjacent to the lower end of the reactor and is configured such that at least some of the insoluble solids that sink to the bottom of the process solution are guided by the conical side wall portion through the relatively narrow outlet opening, and
wherein the solids removal mechanism is operably configured to receive a portion of the insoluble solids that is guided by the conical side wall portion through the relatively narrow outlet opening and to expel the insoluble solids portion through an outlet.

4. The system of claim 3,
wherein the solids removal mechanism comprises a feed screw rotatably disposed in a feed pipe,
wherein the feed pipe includes an inlet that is operably connected to the reactor housing adjacent to the lower end of the reactor such that the portion of the insoluble solids that is guided by the conical side wall portion through the relatively narrow outlet opening is directed into the feed pipe, and
wherein the feed screw mechanism also includes a motor configured to rotate the feed screw within the feed pipe such that the portion of the insoluble solids disposed in the feed pipe is impelled by rotation of the feed screw toward the outlet.

5. The system of claim 3,
wherein the outlet device comprises a pipe mounted to the side wall of the reactor housing such that an inlet of the pipe is disposed inside the reactor chamber and an outlet of the pipe is disposed outside the reactor housing, and
wherein the outlet device is configured such that the inlet is positioned within a region of the process chamber containing a portion of the process solution from which at least some of the divalent ions have been chemically removed.

6. The system of claim 3,
wherein the control system comprises:
at least one sensor disposed in the reaction chamber and configured to generate a process solution pH measurement signal indicating a pH of the process solution disposed in the reaction chamber;
at least one flow control device configured to control both a first flow rate of the aqueous salt feedstock solution into the reaction chamber and a second flow rate of the base product stream into the reaction chamber; and
a controller configured to receive the process solution pH measurement signal and to transmit at least one corresponding flow rate control signal to the at least one flow control device such that the pH of the process solution is maintained at the divalent precipitation pH level.

7. The system of claim 1,
wherein the chemical precipitator comprises a plurality of series connected reactors, each said reactor including a reactor housing containing a portion of the process solution, and
wherein the control system is configured to maintain the process solution portion contained in each of the series connected reactors at a different target divalent precipitation pH level such that each of the series connected reactors produces a corresponding different selected insoluble solid.

8. The system of claim 1, wherein the electrochemical reactor comprises:
an electrodialysis (ED) apparatus including a plurality of chambers arranged in series between opposing electrodes and respectively separated by an intervening ion exchange membrane; and
a flow control system configured to direct an aqueous acid solution into a first chamber of the plurality of chambers and to direct said acid product stream away from said first chamber, and to direct the aqueous salt/base solution into a second chamber of the plurality of chambers and to direct said base product stream away from said second chamber,
wherein the ED apparatus is configured such that chloride ions disposed in the aqueous salt/base solution pass from the second chamber through the ion exchange membrane into the first chamber.

9. The system of claim 8, wherein the ED apparatus comprises an ion exchange stack including a plurality of said acid chambers and a plurality of said salt/base chambers aligned in an alternating arrangement between an anode and a cathode such that each said acid chamber is disposed between first and second salt/base chambers, and such that an electric field generated between the anode and the cathode passes through the plurality of acid chambers and the plurality of salt/base chambers.

10. The system of claim 9, wherein the one or more intervening ion exchange membranes comprises one or more anion exchange membranes and one or more bipolar membranes disposed in an alternating arrangement between adjacent pairs of said acid chambers and said salt/base chambers such that said each acid chamber is separated from the first adjacent salt/base chamber by an associated said anion exchange membrane and is separated from the second salt/base chamber by an associated said bipolar membrane.

11. The system of claim 8 further comprising a fluid buffering system including at least one of:
an acid buffer tank configured to contain the aqueous acid solution directed into said first chamber of the ED apparatus and to receive a portion of the acid product stream directed away from said first chamber of the ED apparatus; and
a salt/base buffer tank operably coupled between the chemical precipitator and the ED apparatus and configured to supply the aqueous base solution directed into said second second chamber of the ED apparatus.

12. The system of claim 8,
wherein the ED apparatus comprises an ion exchange stack including a plurality of cells arranged in series between an anode and a cathode,
wherein each said cell includes an acid chamber and a salt/base chamber separated by an ion exchange membrane and sandwiched between first and second bipolar membranes.

13. The system of claim 8,
wherein the electrochemical reactor further comprises a post-production subsystem configured to utilize a second portion of the base product stream to generate an ocean alkalinity product, and
wherein the system is configured to supply the ocean alkalinity product to an ocean at a designated outfall location.

14. The system of claim 8, further comprising an alkaline solids processor configured to perform one of: (i) redissolving the insoluble solids in seawater using land-based containers (so dissolution can be directly measured) and then returning the seawater to the ocean for OAE (after pre-equilibration or not); (ii) dispersing the insoluble solids in the ocean directly (near or offshore} for OAE; (iii) packaging the insoluble solids for resale to perform useful purposes; and/or (iv) utilizing the insoluble solids as an air capture sorbent.

15. The system of claim 1, further comprising a feedstock pretreatment unit configured to generate the aqueous salt feedstock solution provided to the chemical precipitator by removing solid contaminants from a raw salt feedstock solution.

16. The system of claim 15, wherein the pretreatment unit comprises at least one of a first filtering system configured to remove solid particles from the seawater/brine, and a second filtering system configured to remove one or more of metals and biologic materials from the raw salt feedstock solution.

17. The system of claim 16,
wherein the electrochemical reactor comprises:
an acid buffer tank configured to contain an aqueous acid solution; and
an electrodialysis (ED) apparatus including a plurality of cells arranged in series between an anode and a cathode, wherein each said cell includes an acid chamber, an associated salt/base chamber and an ion exchange membrane configured to transmit ions between the acid chamber and the associated salt/base chamber,
wherein the system further comprises a flow control system configured to direct at least a portion of the aqueous acid solution from the acid buffer tank to the acid chamber of each said cell of the ED apparatus and to separately direct the aqueous base solution from the chemical precipitator to the salt/base chamber of each cell of the ED apparatus.

18. A method for removing divalent ions from an aqueous salt feedstock solution before salt provided in the aqueous salt feedstock solution is processed by an electrochemical reactor to generate both an acid product and a base product, the method comprising:
utilizing a portion of the base product generated by the electrochemical reactor to increase a pH level of the aqueous salt feedstock solution above a precipitation level of one or more of the divalent ions, thereby causing said one or more of the divalent ions to precipitate in the form of insoluble solids disposed in a supernatant solution; and
supplying the supernatant solution to the electrochemical reactor.

19. A method comprising:
utilizing an electrochemical reactor to electrochemically process an aqueous salt solution into an acid product stream including an acid product and a base product stream including a base product;
generating a process solution by mixing a portion of the base product stream and an aqueous salt feedstock solution, said aqueous salt feedstock solution containing salt and divalent ions, wherein said generating comprises controlling a proportion of said base product stream portion to the aqueous salt feedstock solution such that a pH of the process solution is at a divalent precipitation pH level that causes the divalent ions to precipitate in the form of insoluble solids;
generating the aqueous salt solution by removing the insoluble solids from the process solution; and
directing the aqueous salt solution to the electrochemical reactor.

20. (canceled)
